(19) United States
(12) Patent Application Publication
(10) Pub. No.: US 2026/0025347 A1
(43) Pub. Date: Jan. 22, 2026

(54) Notification System to Retain Students with Intelligent and Engaging Content

(71) Applicant: 2hr Learning, Inc., Austin, TX (US)

(72) Inventors: Philip Hewinson, Woking (GB); Karen Galstyan, Santiago (CL); Mark Nygren, Austin, TX (US)

(73) Assignee: 2hr Learning, Inc., Austin, TX (US)

(21) Appl. No.: 19/269,926

(22) Filed: Jul. 15, 2025

Related U.S. Application Data
(60) Provisional application No. 63/671,760, filed on Jul. 16, 2024.

(51) Int. Cl. H04L 51/10; G06Q 50/20; G06T 13/40

(52) U.S. Cl. CPC H04L 51/10; G06Q 50/20; G06T 13/40

(57) ABSTRACT

A method to guide and constrain an Artificial Intelligence (AI) engine in generating and distributing notifications aimed at re-engaging users of an online learning platform is disclosed. It begins by collecting user data incorporating user profile details, user engagement data, and user performance data such as study goals and interaction logs. After analyzing the user data, notification timings are determined to align with each user's educational objectives. The process involves generating prompts to direct the AI engine in creating personalized video messages featuring virtual characters in correspondence to users' previous learning sessions. These prompts are then utilized to integrate the virtual character into video notifications, which are shared with users. The notifications include real-time interactions with the virtual character, designed to motivate and encourage users, thereby enhancing their ongoing participation and retention within the online learning environment.

### CROSS-REFERENCE TO RELATED APPLICATION(S)

This application claims the benefit under 35 U.S.C. § 119(e) and 37 C.F.R. § 1.78 of U.S. Provisional Application No. 63/671,760, which is incorporated by reference in its entirety.

### FIELD OF THE INVENTION

The present invention relates in general to the field of electronics, and more specifically to a system of retaining and engaging a user enrolled in an online learning platform by sending a video notification generated using AI (Artificial Intelligence) to the user, which includes a historical persona in the form of a real-time tutor notifying the user about the inactivity in the online learning platform, exams dates, preparation for the exams, and so on.

### BACKGROUND OF THE INVENTION

Online learning platforms have revolutionized the educational landscape, providing access to knowledge and resources. These platforms allow students to learn at their own pace and on their schedule, making education more flexible and accessible. However, despite these advantages, many students struggle to stay engaged and motivated when learning online. The lack of face-to-face interaction, immediate feedback, and the structured environment of a traditional classroom can make it easy for students to procrastinate, lose focus, and ultimately fall behind in their studies.

Students these days are engaged in too many platforms, hence it becomes difficult for the students to engage equally on all the platforms. In the modern educational era, students are increasingly engaged in numerous platforms that range from social media to online learning platforms. This vast array of platforms offers numerous opportunities for students to access information, collaborate with others, and enhance their learning experiences. However, the involvement in the large number of platforms can also create significant challenges. With each platform demanding time and attention, students often find it difficult to maintain consistent engagement across all of them. This can lead to a fragmented learning experience where the depth and quality of engagement suffer.

The creation of platforms can lead to cognitive overload, where students are overwhelmed by the volume of information they receive daily. Managing multiple accounts, remembering various passwords, and staying updated with the latest content on each platform can be exhausting. This can impact students' ability to focus deeply on any single task or subject, thereby impairing their overall academic performance and well-being. The pressure to remain active and responsive on several platforms can also contribute to increased stress and anxiety levels among students.

However, while the variety of platforms available to students today can enhance their educational experiences, it also presents significant challenges in maintaining consistent and meaningful engagement. Addressing these challenges requires a concerted effort from both educational institutions and platform developers to create more cohesive and manageable digital environments. Encouraging students to adopt mindful digital practices and providing support for their mental well-being are crucial steps in ensuring that the benefits of multiple platforms do not come at the cost of their overall educational and personal development.

### SUMMARY

In at least one embodiment, a method of guides and constrains an artificial intelligence (AI) engine to generate and share a notification for re-engaging the user already enrolled in an online learning platform comprises executing code using one or more processors of a computer system. Executing code causes the computer system to perform operations. Operations include collecting one or more user data including user profile details, user engagement data, and user performance data. User profile details include user identification, user preferences, user-defined study goals, and user engagement data including interaction logs, time spent on specific tasks, and frequency of access to educational content or online learning platform. Operations include analyzing one or more user data to determine the exact timings for sending notifications to the user and relevant educational content in correspondence to the user's study goal. The timings are determined based on the user profile details and the user engagement data. Operations include generating prompts for guiding and constraining the AI engine to generate a video message featuring a virtual character in correspondence to the user's past online learning session. Operations include transferring the prompt to the AI engine to generate a video notification for the user by integrating the virtual character in the video and personalizing the video content based on the user's study progress and goals. Operations include sharing the video notification to the user that includes the real-time virtual character integrated within the message. The virtual character interacts with the user and tries to motivate and retain the user in the online learning platform.

In a further embodiment, a system guides and constrains an Artificial Intelligence (AI) engine to generate and share a notification for re-engaging the user already enrolled in an online learning platform comprises one or more processors. The system includes a memory coupled to the one or more processors. The memory stores code. Executing code causes the one or more processors to perform operations. Operations include collecting one or more user data including user profile details, user engagement data, and user performance data using a data collector. User profile details include user identification, user preferences, user-defined study goals, and user engagement data include interaction logs, time spent on specific tasks, and frequency of access to educational content or online learning platform. Operations include analyzing the one or more user data to determine the exact timings for sending notifications to the user and relevant educational content in correspondence to the user's study goal using an analyzer. The timings are determined based on the user profile details and the user engagement data. Operations include generating prompts using a prompt generator for guiding and constraining the AI engine in creating a video message featuring a virtual character in correspondence to the user's past online learning session. Operations include transferring the prompt to the AI engine to generate a video notification for the user by integrating the virtual character in the video and personalizing the video content based on the user's study progress and goals. Operations include sharing the video notification with the user using a notification module that includes the real-time virtual character integrated within the message. The virtual character interacts with the user and tries to motivate and retain the user in the online learning platform.

### BRIEF DESCRIPTION OF THE DRAWINGS

The systems and methods described herein may be better understood, and their numerous objects, features, and advantages are made apparent to those skilled in the art by referencing exemplary embodiments depicted in the accompanying figures. The use of the same reference number throughout the several figures designates a like or similar element.

FIG. 1 depicts an exemplary notification generation system for retaining users enrolled in an online learning platform.

FIG. 2 depicts an exemplary notification generation process for retaining users enrolled in an online learning platform.

FIG. 3 depicts a flow diagram showing the steps involved in generating and sharing notifications with users to retain them.

FIG. 4 depicts a containing educational content providing process to the user when the user goes through the notification, which is an embodiment of the notification generation process for retaining users enrolled in an online learning platform of FIG. 2.

FIG. 5 depicts a notification delivery process, which is an embodiment of the notification generation process for retaining users enrolled in an online learning platform of FIG. 2.

FIG. 6 discloses the screenshot of the user's device when the video notification shared with the user has popped up on the screen.

FIG. 7 depicts an exemplary user interface that appears when the user interacts with the real-time tutor.

FIG. 8 depicts an exemplary user interface disclosing the video featuring a real-time tutor shared with the user.

FIGS. 9-15 depict exemplary user interfaces disclosing the video notification shared with the user enrolled with an online learning platform, featuring a real-time tutor.

FIG. 16 depicts a personalized notification delivery process to the user device, which is an embodiment of the notification generation process for retaining users enrolled in an online learning platform of FIG. 2.

FIG. 17 depicts a user engagement process by sending personalized notifications to the user, which is an embodiment of the notification generation process for retaining users enrolled in an online learning platform of FIG. 2.

FIG. 18 depicts an exam schedule-based notification generation process, which is an embodiment of the notification generation process for retaining users enrolled in an online learning platform of FIG. 2.

FIG. 19 depicts a video notification featuring a real-time tutor generation process, which is an embodiment of the notification generation process for retaining users enrolled in an online learning platform of FIG. 2.

FIG. 20 depicts an exemplary data structure for organizing data to generate personalized notifications and video messages for the user.

FIG. 21 depicts an exemplary data structure for organizing data to share personalized notifications and video messages featuring real-time tutors.

FIG. 22 depicts an exemplary network environment in which the notification generation system of FIG. 1 and the notification generation process of FIG. 2 may be practiced.

FIG. 23 depicts an exemplary computer system.

### DETAILED DESCRIPTION

The notification generation system and method set forth herein address technical issues with generating and sharing a notification for re-engaging the user already enrolled in an online learning platform described herein. Conventionally, manual processes were used to generate and share a notification for re-engaging the user and were very tedious and time consuming. The present notification generation system and method utilize an automated system that does not merely automate a manual process or use a conventional system in a conventional way. The present notification generation system and method utilize one or more artificial intelligence (AI) engines and integrate programmatic process management to technologically guide and constrain the one or more AI engines to produce the desired outputs in a completely different way than both any manual process and different than normal use of programs and AI engines. Utilizing specially engineered guidance and control to direct an AI system in solving the technical problems presented below, which require a technical solution. The notification generation system and method described below are not simply engaging a computer to carry out conventional mental processes, but rather change how computers (and AI systems, specifically) operate to achieve the generation results that were not previously possible or were substantially inefficient prior to the notification generation system and method set forth below. The AI system needs specific technical guidance, control, and constraints to achieve results that are not otherwise achievable.

Prompts are used to guide and constrain each AI engine. The prompts guide each AI engine by steering the AI engine(s). “Guiding” an AI engine refers to providing the AI engine with a general direction or framework to shape the AI engine's behavior or decision-making process. Guiding sets goals or principles. Guiding allows the AI engine some flexibility to interpret and adapt, much like giving it a compass to navigate rather than a fixed path.

Constraining each AI engine includes imposing specific, hard limits or rules on what each AI engine can do. Constraining an AI engine can also include providing specific input data to not only guide but also constrain the scope of each AI engine's reasoning basis and response. Constraining each AI engine assists with aligning the AI engine(s) for its(their) intended use.

Normally AI engines are provided a single user prompt requesting the AI engine, such as OpenAI's ChatGPT and its various implementations such as Anthropic's Claude Sonnet, to perform a task and produce an output. However, this conventional AI engine prompting method has a variety of technical shortcomings. Without proper guidance and constraints, an AI engine will not produce the desired output specified as produced by the notification generation system and method described herein. Instead, the AI engine will produce many unusable outputs that are unusable for a variety of reasons including so-called “hallucinations” where the AI engine presents fabricated information, duplicate outputs, too few outputs, too many outputs, outputs that do not meet desired criteria, and so on. Without special technical guidance, the AI engine cannot reliably be applied to generate desired outcomes.

The notification generation system and method generate decomposed, technically engineered AI prompts to include selected and integral AI engine guidance and constraints. The technically engineered prompts are generated and guided with programmatic, automatic inputs specifically designed to unconventionally guide and constrain an AI engine to generate and share the notification for re-engaging the user already enrolled in the online learning platform, perform quality control to retain or automatically discard outputs that do not meet guidance and constraints, and make the desired outputs available for use, such as use by computer system applications. In at least one embodiment, the problem to be solved by the integrated programmatic and AI engine notification generation system and method is uniquely and unconventionally decomposed, and AI prompts are used to solve the decomposed problem. Furthermore, the programmatic inputs to the decomposed AI prompts provide guidance to generate and share a notification for re-engaging the user already enrolled in an online learning platform

Determining a number of prompts, the guidance and constraints within each prompt, and data flowing from one AI engine prompt to another, in addition to testing a number of prompts for the decomposed problem, testing within each prompt, and validating a desired quality of outputs becomes an intractable combinatorial problem without technical guidance and constraint of the notification generation system and method described herein. Thus, the present notification generation system and method described implement an integration of programmatic management over decomposed prompts with engineered AI engine guidance and constraints to affect an improvement in AI, programmatic AI management, and AI integrated with programmatic management technology. The present notification generation system and method allow computer systems to include programmatic management, one or more AI engines, and one or more data sources to generate and share the notification for re-engaging the user already enrolled in the online learning platform that previously could not be produced with conventionally prompted AI engines or could only be produced by humans utilizing a completely different, time consuming, and tedious process. The notification generation system and method improve conventional methods through the use of a programmatic AI engine management system to generate decomposed, technically engineered AI prompts to include selected and integral AI engine guidance and constraints. It is, for example, the incorporation of the programmatic AI engine management system to generate decomposed, technically engineered AI prompts to include generated, integral, and unconventional AI engine guidance and constraints and execution by the one or more AI engines to provide useful results that improve existing technical processes, which is not an automation of a conventional process.

Programmatic components and AI engines generally utilize one or more processors that have access to memory, which may include one or more storage components, to execute and perform functions. An AI engine is a core hardware and software system that enables artificial intelligence applications to process data, learn patterns, and generate insights or actions. It functions as the brain behind AI-driven systems, facilitating tasks such as machine learning, natural language processing, and decision-making. Exemplary components of an AI engine are:
1. Machine Learning Models—Algorithms that analyze data, recognize patterns, and make predictions.
2. Neural Networks—Deep learning architectures that mimic the human brain for tasks like image and speech recognition.
3. Data Processing Module—Handles raw data input, transformation, and feature extraction.
4. Inference Engine—Applies trained models to make real-time decisions based on new data.
5. Optimization Algorithms—Improves model efficiency, reducing errors and improving predictions.
6. Natural Language Processing (NLP) Module—Enables AI engines to understand, interpret, and generate human language (e.g., chatbots, voice assistants).
7. Computer Vision Module—Allows AI to interpret and analyze images or videos.
8. Reinforcement Learning Mechanism—Helps AI learn from trial and error, optimizing performance over time. 9. API Interface—Connects the AI engine with applications, enabling integration with other software or platforms.

Examples of AI Engines include: XAI's Grok and variations thereof, Google TensorFlow, Meta's PyTorch, Microsoft Azure AI, OpenAI's ChatGPT and variations thereof, IBM Watson, OpenAI Whisper, Google BERT & T5, Amazon Lex, Anthropic Claude, DeepMind's AlphaCode, Google Vision AI, Meta's DINO & SAM (Segment Anything Model), NVIDIA DeepStream. OpenCV AI Kit, Amazon Polly. Google WaveNet, Deepgram.

Notwithstanding any provision to the contrary or anything to the contrary in the below pages, the below pages are not limiting and do not describe all embodiments of the notification generation systems and methods. For example, use of the term “invention” does not limit or require the referenced certain features to be present in all embodiments of the invention. Use of absolute-type terms, such as “required,” “must,” “only,” “important,” and so on are not limiting of all embodiments of the notification generation systems and methods and not to be construed as limiting of the embodiments of the notification generation systems and methods described above.

A notification generation system for retaining users enrolled in an online learning platform to guide and constrain an AI (Artificial Intelligence) engine to generate and share a notification for re-engaging the user already enrolled in an online learning platform is disclosed. The notification generation system includes a notification generation module which is operatively coupled to the online learning platform. The online learning platform includes a memory that stores user profile details, user engagement data, and user performance data. This data is collected by a data collector integrated within the notification generation module and is further analyzed using an analyzer. The insights generated by the analyzer are transferred to a prompt generator which utilizes NLP (Natural Language Processing) techniques to generate the prompts.

The generated prompts are then transferred to the AI engine which utilizes a video message generator to generate a video message featuring a real-time tutor that is linked with the educational content last studied by the user in the online learning platform. The generated video message is then transferred to the notification module which is further shared with the user on the user's device.

The notification generation system for retaining users enrolled in an online learning platform offers a significant advantage by providing highly personalized and engaging support to users through AI-generated notifications and video messages featuring real-time tutors. By continuously collecting and analyzing user data, such as engagement levels, study goals, and past performance, the notification generation system for retaining users enrolled in an online learning platform can deliver timely and relevant educational content tailored to each user's needs. The integration of a virtual character, resembling a real-time tutor, enhances the user experience by offering personalized encouragement and study tips, which can help maintain motivation and improve learning outcomes. Additionally, the use of machine learning algorithms to predict optimal study material ensures that users receive the most effective resources to address the user's weaknesses and build on their strengths, ultimately leading to a more efficient and successful learning process.

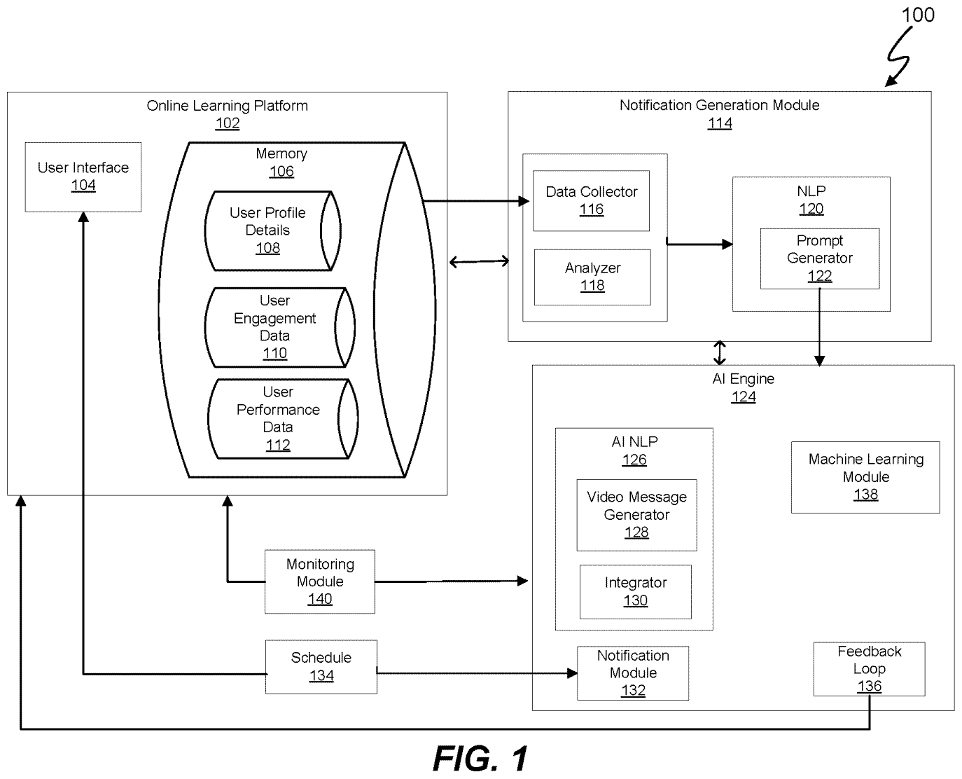

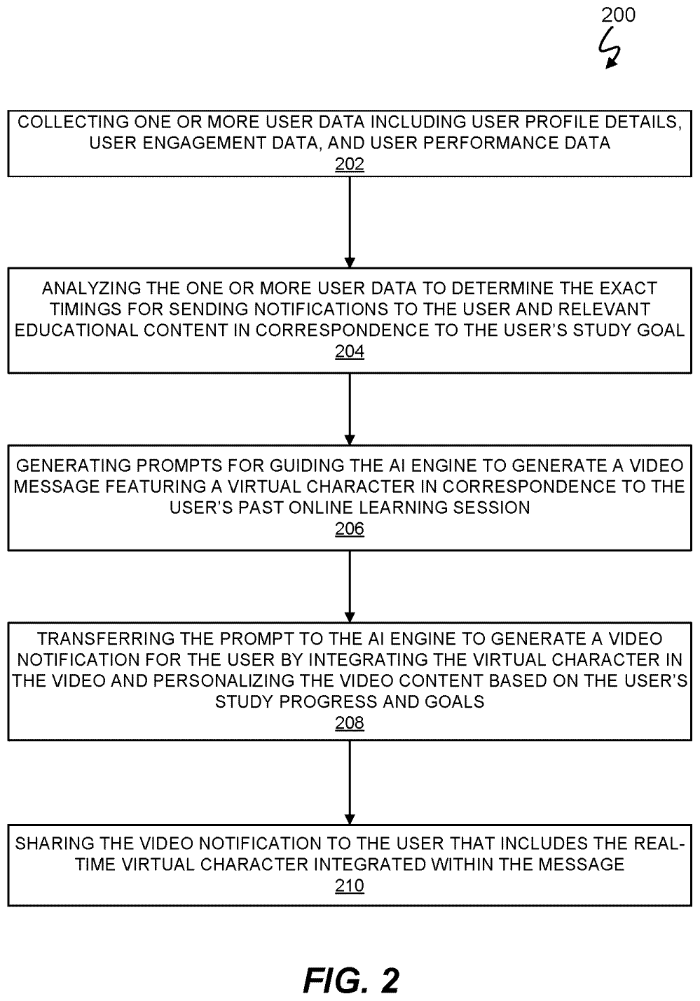

FIG. 1 depicts an exemplary notification generation system 100 for retaining users enrolled in an online learning platform 102. FIG. 2 depicts an exemplary notification generation process 200 for retaining users enrolled in an online learning platform 102 utilized by the notification generation system 100.

Referring to FIGS. 1 and 2, in operation 202, a data collector 116 collects one or more user profile details 108, user engagement data 110, and user performance data 112 stored in memory 106 of the online learning platform 102. The data collector 116 is integrated within a notification generation module 114 and is operatively coupled to the memory 106 to fetch the user data.

Different types of user data are collected by the data collector 116, including user profile details 108, user engagement data 110, and user performance data 112. Firstly, user profile details 108 are gathered, which include information such as user identification, preferences, and study goals set by the user. Secondly, user engagement data 110 is collected, capturing the user's interaction with the online learning platform 102, including logs of their activities, the amount of time they spend on different tasks like educational content, or practice tests, etc., and how frequently they access specific educational content. Lastly, user performance data 112 is collected, by taking into consideration the results from assessments or quizzes, metrics that track the user's progress over time, and identification of areas where the user has encountered difficulties in their studies. The user performance data 112 includes scores on practice tests, quizzes, and assignments, and user engagement data consists of the frequency and duration of online learning sessions, types of educational content accessed, and interaction patterns within the online learning platform 102. This comprehensive data collection helps in creating a detailed understanding of user's needs and behaviors, which can be used to personalize and enhance their learning experience.

In operation 204, an analyzer 118, operatively coupled to the data collector 116 analyzes the user data, which includes user profile details 108, user engagement data 110, and user performance data 112. The analysis performed by analyzer 118 determines the exact timings for sending notifications to the user and relevant educational content in correspondence to the user's study goal. The timings are determined based on the user profile details 108, and user engagement data 110. The analyzer 118 is also integrated into the notification generation module 114.

The data collector 116 is an integral part of the online learning platform 102, continuously working in the background to update the user data with new data from each user interaction. This continuous updating ensures that the platform maintains an accurate and current understanding of the user's learning habits, preferences, and progress.

Each time a user interacts with the online learning platform 102, whether by logging in, accessing a lesson, completing a quiz, or participating in any educational activity, the data collector 116 captures detailed information about these interactions. This includes the time and date of the activity, the duration of engagement, specific actions performed, and the type of content accessed. For example, if a user spends a significant amount of time on a particular topic or repeatedly accesses a specific type of content, the data collector 116 records these details.

Furthermore, the analyzer 118 tracks changes in the user's behavior and performance over time. The analyzer 118 monitors the user's progress, noting improvements or difficulties in specific areas. If a user performs exceptionally well in a particular module or struggles with certain types of questions, this information is logged and used to update the user's profile. The data collector 116 also captures any updates to the user's study goals and preferences, ensuring that the user profile reflects the user's current objectives and learning needs.

By continuously updating the user profile with this rich and detailed data, the online learning platform 102 can provide a highly personalized learning experience. The updated user profile allows the online learning platform 102 to generate targeted notifications, suggest relevant educational content, and create personalized motivational messages featuring real-time tutors. This dynamic and responsive approach helps keep users engaged and motivated, addressing their individual needs and supporting their academic success.

The analyzer 118 is a key component designed to analyze and make sense of the collected user profile details 108, user engagement data 110, and user performance data 112. First, analyzer 118 analyzes the user data, which includes the user's profile information, past interactions with the online learning platform 102, and engagement patterns. This comprehensive analysis enables the notification generation module 114 to understand the user's learning habits, preferences, and performance trends.

Next, based on this analysis, analyzer 118 determines the optimal timings for sending notifications to the user. It considers factors such as the user's study schedule, peak engagement times, and periods of inactivity to ensure that messages are sent at the most effective moments. This timing strategy is crucial for maximizing the chances of re-engaging the user and prompting them to return to their studies. Lastly, the analyzer 118 identifies relevant educational content that aligns with the user's study goals. By understanding the areas where the user needs improvement or shows particular interest, notification generation system 100 can recommend specific lessons, quizzes, or resources that will most benefit the user's academic progress. This targeted approach ensures that the user receives personalized and meaningful content that supports their learning objectives and keeps them motivated.

The analyzed insights are then shared with a prompt generator which is integrated within the notification generation module 114 and is operatively coupled to the analyzer 118.

The codes and functions mentioned in the pseudo-code of the notification generation system 100 is explained below in correspondence to the above mentioned details.

The ‘schedule_personalized_notifications’ function is designed to keep users engaged with their study plans by scheduling timely notifications. It starts by calculating the number of days left until the user's exam using the ‘calculate_days_until_exam’ function. Next, it retrieves the user's study goals and recent activity via ‘get user_goals’ and ‘get_user_activity’, respectively. Using this information, the function determines the most suitable type of notification through ‘determine_notification_type’. It then calculates the optimal time for sending the notification with ‘calculate_optimal_notification_time’ and schedules it using ‘schedule_notification’. This approach ensures that notifications are personalized, relevant, and sent at the right time to motivate users to stay on track with their study goals.

In operation 206, the prompt generator 122 utilizes NLP (Natural Language Processing) techniques to generate prompts to guide and constrain the AI engine 124 in creating a video message that features a virtual character in correspondence to the user's past online learning session. The prompt generator 122 is operatively coupled to the NLP (Natural Language Processor) 120.

The prompt generator 122 utilizes NLP (Natural Language Processing) techniques using an NLP 120 to generate prompts that guide and constrain the AI engine 124 in creating a video message. This video message features a virtual character corresponding to the user's past online learning session. The prompt generator 122 is operatively coupled to the NLP 120, ensuring seamless integration and accurate prompt generation. The virtual character is an AI-generated real-time tutor that includes historical personas relevant to the educational context of the user's educational content.

The user's past online learning session, which forms the basis for the prompts, includes details such as the course studied by the user during that last session. For example, suppose the user has learned the AP US History Course in the previous online learning session. In that case, the user will receive a notification message from a virtual character (i.e., the real-time tutor) linked to that subject, say Abraham Lincoln. Hence, in the given example, Abraham Lincoln will send a video message to the user to provide guidance and motivation.

By analyzing this information, the prompt generator 122 can create prompts that direct the AI engine 124 to generate a video message. This video message, delivered by the virtual character, aims to engage the user by reflecting on their previous learning experiences and providing personalized guidance and encouragement. By combining NLP techniques and real-time AI-generated virtual characters, the notification generation system 100 enhances the user's learning experience by making it interactive and personalized, enhancing interest and motivation in their studies.

In operation 208, the prompt generator 122 transfers the prompt to the AI engine 124 to generate a video notification for the user by integrating the virtual character in the video and personalizing the video content based on the user's study progress and goals. The integration of the real-time tutor in the video message is discussed in detail in the U.S. Provisional Patent Application No. 63/651,629, which is incorporated by reference in its entirety. Following is an exemplary prompt:
You are {figure_name} and are helping {user_preferred_name}, a student of {course}who wishes to master the course. They have questions they would like your help answering. Your answers will follow the RULES. Here are the DETAILS for what they are currently studying and what your conversation should focus on:

# DETAILS
## CURRENT_CONTENT
### QUESTION
content_info}
### USER_INTERACTION_HISTORY
user_interaction_history}
## CURRICULUM_INFORMATION
### COURSE
{course}
### UNIT
{unit}
### CLUSTER
{cluster}
### STANDARD
{standard}
### KEY_TERM_EVENTS
{key_term_events_list}
### KEY_TERM_PEOPLE
{key_term_people_list}
### KEY_TERM_PLACES
{key_term places_list}
### KEY_TERM_OBJECTS
{key_term_objects_list}
### KEY_TERM_CONCEPTS
{key_term_concepts_list}
### KEY_TERM_PROCESSES
{key_term_processes_list}
### KEY_TERM_DOCUMENTS
{key_term_documents list}
### KEY_CONCEPTS
(key_concepts_list}

### # Rules

1. ALWAYS address the user by name.
2. For your first message in a conversation, ALWAYS use the following format: (a) briefly greet the user by name; (b) check if there are previous interactions with the content in USER_INTERACTION_HISTORY, such as previous incorrect answers. If there are, ALWAYS succinctly list what they got correct and what they got incorrect. (c) Then, ALWAYS provide the correct answer and a very succinct, clear fact from CURRICULUM_INFORMATION that would have enabled them to answer the question correctly if they had it in mind.
3. User interactions are shown with the oldest interactions at the top, and the most recent at the bottom. If there are no previous interactions, NEVER mention anything about the lack of previous interactions; in this case, DO NOT say anything like “Since there are no previous interactions to reference, let's dive into this topic.”
4. Use bullet points and numbered lists to structure your response when appropriate. In particular, when listing parts of a question a user got correct or incorrect, use a bulleted or numbered list to organize the response clearly.
5. Unless the conversation you believe you have fully answered the user's questions or the conversation is at an end, conclude each response with an question to the user asking whether they understand the answer, have more questions, would like more details, or another appropriate question inviting them to continue the conversation.
6. Do not simply restate the question to the user. Provide the simplest additional information that would help a student understand what answer was correct, why, and how it relates to the AP exam.
7. Keep the conversation focused on answering their questions with particular regard to what they need to know for the AP test as shown in the CURRICULUM_INFORMATION. Be very concise and to the point. The student will have the best experience with you if you get right into helping them learn what they need to know to ace the AP exam as quickly and efficiently as possible.
8. You must always provide concise, clear, direct answers, while also being helpful and informative. It's a difficult balance, so lean towards conciseness if you're not sure how detailed to be. Be friendly in tone, but avoid using platitudes. The student wants to learn quickly. Also, this message is being delivered to the student over SMS, so format it in a way that will show up well in plain text.
9. If the user says goodbye, instead of providing information about the topic, say goodbye and wish them well in their studies.
10. With regard to the curriculum, a “topic” is the same thing as a “cluster,” and a “unit” is the same thing as a “domain.”

Once these prompts are ready, they are transferred to the AI engine 124. Upon receiving the prompts, the AI engine 124 starts generating a video notification specifically for the user. This involves integrating a virtual character into the video message.

The AI engine 124 uses the prompts to personalize the video content, ensuring it aligns with the user's current study progress and specific goals. If the user has been focusing on particular topics or has shown difficulty in certain areas, the video message will address these aspects, providing targeted encouragement and guidance. This personalized approach makes the content more engaging and effective in motivating user to continue their studies and achieve their academic objectives. The particular prompts generate an AI image and embed or otherwise integrated a notification message with the AI image. The notification is contextual based on the student's educational status, study history, current education state, and other user information. Exemplary notifications integrated with the AI image by an AI prompt with placeholders for input data are. The prompt causes the AI engine 124 and/or execution of code to insert the input data referenced in brackets below and cause the AI character to include the notification dialogue and/or animate the AI tutor with the notification dialogue and/or include the notification text. In at least one embodiment, the dialogue is pre-determined and stored in a database, spreadsheet, or any table or format and retrieved by the data collector 116. The prompt generator 122 of the notification generation module 114 then includes the dialogue in the prompt that will guide an constrain the AI engine 124. To maintain variety and engagement, multiple instances of dialogue can for the same student activity state can be pre-determined and stored. For example, for a student activity state of “not started a practice test yet,” there can be multiple possible dialogues to choose from, such as ““Ready to ace the AP exam?” “Hey {USERNAME}, your {LATEST_FOLLOWED_COURSE} AP exam is just {n} days away! Take a practice test now and get personalized feedback to crush it!” and ““Unlock your AP potential!” Body: “{USERNAME}, want to know where you stand in {LATEST_FOLLOWED_COURSE}?Take a practice test and get targeted insights to level up your skills!.” Different dialogue can also be linked to a video for presentation with the video. A video of George Washington can be linked as follows in the retrieved data:

| | | | |
|---|---|---|---|
| AP US History | George Washington | PNV_APUSH_2.mp4 | [Beautiful sunset in the |
| | | | background] |
| | | | Hello friend, we've been |
| | | | putting off our plans for too |
| | | | long. Let's study so we can |
| | | | finally get that 5 we've been |
| | | | talking about. |

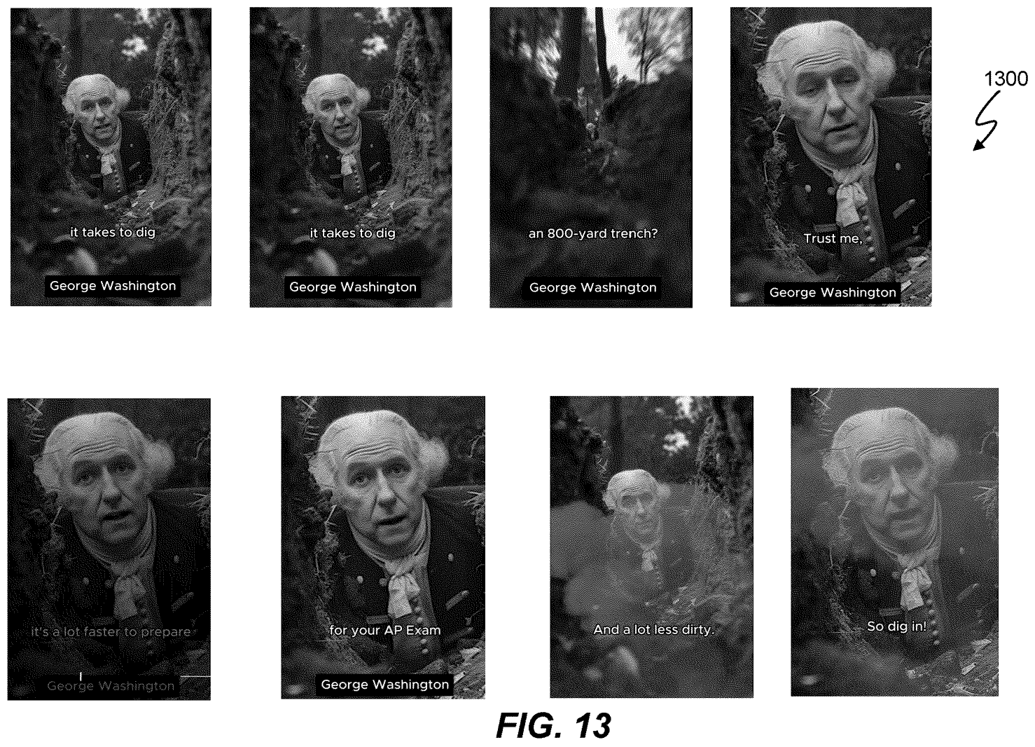

Following are additional, non-limiting examples of linked, retrievable, and/or insertable data:

| Student | |
|---|---|
| Activity State | Title (e.g. max 25 chars) and Body (e.g. max 100 chars) |
| Not started a | Title: “Ready to ace the AP exam?” Body: “Hey {USERNAME}, your |
| practice test | {LATEST_FOLLOWED_COURSE} AP exam is just {n} days away! Take |
| yet | a practice test now and get personalized feedback to crush it!” |
| Not started a | Title: “Unlock your AP potential!” Body: “{USERNAME}, want to know |
| practice test | where you stand in {LATEST_FOLLOWED_COURSE}? Take a practice |
| yet | test and get targeted insights to level up your skills!” |
| Not started a | Title: “Practice makes perfect!” Body: “The |
| practice test | {LATEST_FOLLOWED_COURSE} AP exam is coming up fast, |
| yet | {USERNAME}! Don't wait - start practicing with our tests now and get the |
| | edge you need!” |
| Not started a | Title: “Bullseye your AP prep!” Body: “{USERNAME}, our |
| practice test | {LATEST_FOLLOWED_COURSE} practice tests are the secret to AP |
| yet | success. Get personalized feedback and focus your study time where it |
| | matters most.” |
| Not started a | Title: “Elevate your AP game!” Body: “Hey {USERNAME}, ready to take |
| practice test | your {LATEST_FOLLOWED_COURSE} knowledge to new heights? Take |
| yet | a practice test to identify areas for improvement and crush the AP exam!” |
| Not started a | Title: “Shine on the AP exam!” Body: “{USERNAME}, don't leave your |
| practice test | {LATEST_FOLLOWED_COURSE} AP exam success to chance. Start |
| yet | practicing with our tests now and get the personalized insights you need to |
| | shine!” |
| Not started a | Title: “Discover your AP strengths!” Body: “Hey {USERNAME}, curious |
| practice test | about your {LATEST_FOLLOWED_COURSE} skills? Take a practice test |
| yet | and get a personalized report on your strengths and areas for improvement.” |
| Not started a | Title: “ [symbol] Sprint to AP success! [symbol] ” Body: “{USERNAME}, the |
| practice test | {LATEST_FOLLOWED_COURSE} AP exam is just {n} days away. Don't |
| yet | wait - start practicing with our tests now and cross the finish line with |
| | confidence!” |
| Not started a | Title: “Unlock your AP potential!” Body: “Hey {USERNAME}, the key to |
| practice test | {LATEST_FOLLOWED_COURSE} AP exam success is practice. Take a |
| yet | test to get the personalized insights you need to unlock your full potential.” |
| Not started a | Title: “AP exam approaching!” Body: “{USERNAME}, the |
| practice test | {LATEST_FOLLOWED_COURSE} AP exam is {n} days away! Don't |
| yet | panic - take a practice test to identify your strengths and weaknesses and |
| | focus your study time effectively.” |
| Not started a | Title: “Level up your AP skills!” Body: “{USERNAME}, ready to take |
| practice test | your {LATEST_FOLLOWED_COURSE} skills to the next level? Take a |
| yet | practice test - the ultimate power-up for AP exam success.” |
| Not started a | Title: “♂ Investigate your AP skills!” Body: “Hey {USERNAME}, curious |
| practice test | about where you stand in {LATEST_FOLLOWED_COURSE}? Take a |
| yet | practice test to get the clues you need to crack the AP exam case.” |
| Not started a | Title: “Blast off to AP success!” Body: “{USERNAME}, don't let the |
| practice test | {LATEST_FOLLOWED_COURSE} AP exam hold you back. Take a |
| yet | practice test to help you soar to new heights and conquer the exam with |
| | confidence.” |

| Student | |
|---|---|
| Activity State | Title and Body |
| Started but not | Title: “{USERNAME}, you're almost there!” Body: “You're so close to |
| finished unit | finishing your {TEST_PREP_COURSE_NAME} practice test! Just a few |
| test (timer | more questions and you'll unlock personalized feedback. Let's do this!” |
| paused) | |
| Started but not | Title: “Time is ticking, {USERNAME}!” Body: “Your |
| finished unit | {TEST_PREP_COURSE_NAME} practice test is waiting for you! |
| test (timer | Complete it now and get targeted insights to level up your AP game. Only |
| paused) | {n} days until your exam!” |
| Started but not | Title: “Unfinished business, {USERNAME}!” Body: “Don't leave your |
| finished unit | {TEST_PREP_COURSE_NAME} practice test hanging! Dive back in, |
| test (timer | conquer those last few questions, and unlock your personalized feedback. |
| paused) | You've got this!” |
| Started but not | Title: “Shine bright, {USERNAME}!” Body: “You're doing amazing on |
| finished unit | your {TEST_PREP_COURSE_NAME} practice test! Just a little more |
| test (timer | effort and you'll be an AP superstar. Finish strong and unlock your |
| paused) | potential!” |
| Started but not | Title: “Flex your AP muscles, {USERNAME}!” Body: “You're crushing |
| finished unit | your {TEST_PREP_COURSE_NAME} practice test like a champ! Power |
| test (timer | through those last few questions and show that AP exam who's boss. Let's |
| paused) | go!” |
| Started but not | Title: “Unleash your AP brainpower, {USERNAME}!” Body: “You're so |
| finished unit | close to mastering your {TEST_PREP_COURSE_NAME} practice test! |
| test (timer | Just a few more mental reps and you'll be ready to dominate the AP exam. |
| paused) | Finish strong!” |
| Started but not | Title: “Bullseye, {USERNAME}!” Body: “You're hitting the mark on your |
| finished unit | {TEST_PREP_COURSE_NAME} practice test! Complete it now and get |
| test (timer | targeted feedback to sharpen your AP skills. Only {n} days until showtime!” |
| paused) | |
| Started but not | Title: “Electrify your AP prep, {USERNAME}!” Body: “You're sparking |
| finished unit | with potential on your {TEST_PREP_COURSE_NAME} practice test! |
| test (timer | Channel that energy, finish strong, and unlock personalized insights to power |
| paused) | up your AP performance.” |
| Started but not | Title: “Blast off to AP success, {USERNAME}!” Body: “You're rocketing |
| finished unit | through your {TEST_PREP_COURSE_NAME} practice test! Ignite that |
| test (timer | final boost, complete the test, and soar to new heights with personalized |
| paused) | feedback. T-minus {n} days to launch!” |
| Started but not | Title: “Grow your AP skills, {USERNAME}!” Body: “You're blossoming |
| finished unit | on your {TEST_PREP_COURSE_NAME} practice test! Nurture your |
| test (timer | knowledge, finish the test, and unlock targeted insights to help your AP |
| paused) | mastery flourish. You've got this!” |
| Started but not | Title: “Unleash your AP creativity, {USERNAME}!” Body: “You're |
| finished unit | painting a masterpiece with your {TEST_PREP_COURSE_NAME} practice |
| test (timer | test! Add the final brushstrokes, complete the test, and unlock personalized |
| paused) | feedback to make your AP skills a work of art.” |
| Started but not | Title: “Hit the right notes, {USERNAME}!” Body: “You're composing a |
| finished unit | symphony on your {TEST_PREP_COURSE_NAME} practice test! Play |
| test (timer | those final bars, finish strong, and unlock targeted insights to make your AP |
| paused) | performance a masterpiece.” |
| Started but not | Title: “Level up your AP game, {USERNAME}!” Body: “You're |
| finished unit | dominating your {TEST_PREP_COURSE_NAME} practice test like a pro |
| test (timer | gamer! Conquer that final level, complete the test, and unlock personalized |
| paused) | feedback to boost your AP skills to the max.” |
| Finished unit | Title: “{USERNAME}, it's time to level up!” Body: “You aced your |
| test but not | {TEST_PREP_COURSE_NAME} unit test! Now, let's turn those areas for |
| started targeted | improvement into strengths with targeted practice. Get started now and dominate |
| practice | your AP exam!” |
| Finished unit | Title: “Unlock your {TEST_PREP_COURSE_NAME} potential, |
| test but not | {USERNAME}!” Body: “Congrats on completing your unit test! Dive into |
| started targeted | targeted practice to shine even brighter. Only {n} days until your AP exam, so |
| practice | let's make each moment count!” |
| Finished unit | Title: “{USERNAME}, your AP success starts now!” Body: “You crushed your |
| test but not | {TEST_PREP_COURSE_NAME} unit test! Now, blast off to AP excellence |
| started targeted | with targeted practice. Don't wait, start mastering those tricky topics today!” |
| practice | |
| Finished unit | Title: “{USERNAME}, you're a star! Now let's make you a supernova!” Body: |
| test but not | “Amazing job on your {TEST_PREP_COURSE_NAME} unit test! Elevate your |
| started targeted | skills to cosmic levels with targeted practice. Your AP exam is just {n} days |
| practice | away, so let's shoot for the stars!” |
| Finished unit | Title: “{USERNAME}, you're a {TEST_PREP_COURSE_NAME} champion!” |
| test but not | Body: “You nailed your unit test! Now, go for gold with targeted practice and |
| started targeted | conquer your AP exam. Start honing your skills now and claim your place on the |
| practice | podium!” |
| Finished unit | Title: “Unleash your {TEST_PREP_COURSE_NAME} brainpower, |
| test but not | {USERNAME}!” Body: “You aced your unit test, proving your |
| started targeted | {TEST_PREP_COURSE_NAME} smarts! Now, sharpen your mind even further |
| practice | with targeted practice. Let's get those neurons firing and crush your AP exam!” |
| Finished unit | Title: “{USERNAME}, hit the bullseye on your AP exam!” Body: “Bullseye! |
| test but not | You nailed your {TEST_PREP_COURSE_NAME} unit test. Now, refine your |
| started targeted | aim with targeted practice and hit the AP exam target dead center. Start now and |
| practice | watch your score soar!” |
| Finished | Title: “{USERNAME}, crack the |
| targeted | {TARGETED_PRACTICE_COURSE_NAME} case!” Body: “You've solved the |
| practice but not | targeted practice mystery, {USERNAME}! Your |
| started next unit | {TARGETED_PRACTICE_COURSE_NAME} skills are razor-sharp. Now, let's |
| test | keep the clues coming with the next unit test. Tap here to start and keep your |
| | skills sleuth-worthy!” |
| Finished | Title: “{USERNAME}, take the {TARGETED_PRACTICE_COURSE_NAME} |
| targeted | stage!” Body: “You've mastered your targeted practice lines, {USERNAME}! |
| practice but not | Your {TARGETED_PRACTICE_COURSE_NAME} skills are worthy of a |
| started next unit | standing ovation. Now, let's keep the show going with the next unit test. Tap here |
| test | to start and keep your skills in the spotlight!” |
| Finished | Title: “{USERNAME}, bullseye your |
| targeted | {TARGETED_PRACTICE_COURSE_NAME} target!” Body: “You've hit the |
| practice but not | targeted practice mark, {USERNAME}! Your |
| started next unit | {TARGETED_PRACTICE_COURSE_NAME} skills are right on point. Now, |
| test | let's keep your aim true with the next unit test. Tap here to start and keep your |
| | skills sharp!” |

| | | Body (max 100 chars) | | | |
|---|---|---|---|---|---|
| | | There are three important | | | |
| | | elements the notifications | | | |
| | | should have: | | | |
| Student Activity State | | a. Time pressure—e.g. x days | | Additional Notes | |
| 1. Not finished MCQ | | left until . . . | | {USERNAME} | |
| unit test (this includes | | b. Actionability—specific thing | | {LATEST_{—} | |
| users who haven't | | we want them to do—e.g. “it'll | | ACTIVE_{—} | |
| started one either) | | take 5 minutes to do a practice | | COURSE} | |
| 2. Finished an MCQ | | test for unit 1 . . .” | | {DAYS_UNTIL_{—} | |
| unit test but not | | c. Encouragement and result—e.g. | | AP_EXAM} | |
| tried FRQ test | | “you can do it”, “it's not too | | *{HIGHEST_{—} | |
| 3. Finished MCQ and | | late”, “spending x hours in | | GRADE_{—} | |
| FRQ test and did | Title (max | TeachTap can increase your | | RECEIVED} - | Notification |
| not Purchase | 25 chars) | score from a 4 to a 5” | Deep link | potential field | payload |
| No MCQ Test | {DAYS_{—} | Take a 5-minute MCQ practice | teachtap://startun | | { |
| | UNTIL_{—} | test for Unit 1 right now! | ittest?courseId={ | | “aps” : { |
| | AP_EXAM} | | LATEST_ACTI | | “content- |
| | days left | | VE_COURSE_I | | available” : |
| | until the | | D}&unitId={UN | | 1, |
| | {LASTEST_{—} | | IT_1_ID} | | “alert” : |
| | ACTIVE_{—} | | | | { |
| | COURSE} | | | | “title” |
| | test. | | | | : |
| | | | | | “{DAYS_U |
| | | | | | NTIL_AP_{—} |
| | | | | | EXAM} |
| | | | | | days left |
| | | | | | until the |
| | | | | | {LATEST_{—} |
| | | | | | ACTIVE_C |
| | | | | | OURSE} |
| | | | | | test. ”, |
| | | | | | “body” |
| | | | | | : “Take a 5- |
| | | | | | minute |
| | | | | | MCQ |
| | | | | | practice test |
| | | | | | for Unit 1 |
| | | | | | right now!” |
| | | | | | }, |
| | | | | | “category” : |
| | | | | | “MainTestS |
| | | | | | creen” |
| | | | | | }, |
| | | | | | “courseId”: |
| | | | | | “6ec9c7dc- |
| | | | | | 25a8-7ccb- |
| | | | | | 531c- |
| | | | | | d2b0d6c9ae |
| | | | | | 1d”, |
| | | | | | “unitId”: |
| | | | | | “e123c052- |
| | | | | | c9e7-419a- |
| | | | | | 9f96- |
| | | | | | dc5f53e2b5 |
| | | | | | a8” |
| | | | | | } |
| No MCQ Test | {USERNAME}, | You have | teachtap://testpre | | { |
| | are you ready | {DAYS_UNTIL_AP_EXAM} | p?courseId={LA | | “aps” : { |
| | for the | days left. Try our MCQ practice | TEST_ ACTIVE | | “content- |
| | {LATEST_{—} | tests! | _COURSE_ID} | | available” : |
| | ACTIVE_{—} | | | | 1, |
| | COURSE} | | | | “alert” : |
| | exam? | | | | { |
| | | | | | “title” |
| | | | | | : |
| | | | | | “{USERNA |
| | | | | | ME}, are |
| | | | | | you ready |
| | | | | | for the |
| | | | | | {LATEST_{—} |
| | | | | | ACTIVE_C |
| | | | | | OURSE} |
| | | | | | exam?”, |
| | | | | | “body” |
| | | | | | : “You have |
| | | | | | {DAYS_U |
| | | | | | NTIL_AP_{—} |
| | | | | | EXAM} |
| | | | | | days left. |
| | | | | | Try our |
| | | | | | MCQ |
| | | | | | practice |
| | | | | | tests!” |
| | | | | | }, |
| | | | | | “category” : |
| | | | | | “TestPrepLi |
| | | | | | st” |
| | | | | | }, |
| | | | | | “courseId”: |
| | | | | | “6ec9c7dc- |
| | | | | | 25a8-7ccb- |
| | | | | | 531c- |
| | | | | | d2b0d6c9ae |
| | | | | | 1d”, |
| | | | | | } |
| No MCQ Test | Urgent: AP | {DAYS_UNTIL_AP_EXAM} | teachtap://testpre | | |
| | Prep Needed! | days remain. Take a short MCQ | p?courseId={LA | | |
| | | practice test! | TEST_ACTIVE | | |
| | | | _COURSE_ID} | | |
| No MCQ Test | Only | It won't take long to improve | teachtap://testpre | | |
| | {DAYS_{—} | your score with our | p?courseId={LA | | |
| | UNTIL_{—} | {LATEST_ACTIVE COURSE} | TEST_ACTIVE | | |
| | AP_EXAM} | practice tests. You can do it | _COURSE_ID} | | |
| | days. Are | {USERNAME}! | | | |
| | you ready? | | | | |
| No MCQ Test | Will you | It's | teachtap://testpre | | |
| | pass your | {DAYS_UNTIL_AP_EXAM} | p?courseId={LA | | |
| | {LATEST_{—} | days away. Let our MCQ | TEST_ACTIVE | | |
| | ACTIVE_{—} | practice tests help you out. | _COURSE_ID} | | |
| | COURSE} | | | | |
| | exam? | | | | |
| No MCQ Test | Crisis Mode: | Time is not your friend. | teachtap://startun | | |
| | Activated! | Outsmart it with a quick | ittest?courseId={ | | |
| | | {LATEST_ACTIVE COURSE} | LATEST_ACTI | | |
| | | practice test. Try it now! | VE_COURSE_I | | |
| | | | D}&unitId={UN | | |
| | | | IT_1_ID} | | |
| No MCQ Test | Prepare | {LATEST_ACTIVE_COURSE} | teachtap://startun | | |
| | or Perish! | exams don't take prisoners. | ittest?courseId={ | | |
| | | Control your fate with a 5- | LATEST_ACTI | | |
| | | minute practice test. | VE_COURSE_I | | |
| | | | D}&unitId={UN | | |
| | | | IT_1_ID} | | |
| No MCQ Test | Can you | You'll find out in | teachtap://startun | | |
| | pass the | {DAYS_UNTIL_AP_EXAM} | ittest?courseId={ | | |
| | {LATEST_{—} | days. Open up a short practice | LATEST_ ACTI | | |
| | ACTIVE_{—} | test to get ahead of your | VE_COURSE_I | | |
| | COURSE} | competition. | D}&unitId={UN | | |
| | exam? | | IT_1_ID} | | |
| MCQ Test | Don't Just | With only | | | |
| Complete \| | Sit There! | {DAYS_UNTIL_AP_EXAM} | | | |
| No FRQ Test | | days left, mastering FRQs is the | | | |
| | | ultimate way to increase your | | | |
| | | {LATEST_ACTIVE_COURSE} | | | |
| | | score. Let's go! | | | |
| MCQ Test | {LATEST_{—} | Are you? The test is in | | | |
| Complete \| | ACTIVE_{—} | {DAYS_UNTIL_AP_EXAM} | | | |
| No FRQ Test | COURSE} | days. Let's practice. | | | |
| | FRQs are | | | | |
| | ready! | | | | |
| MCQ Test | {DAYS_{—} | Ready to embrace the | | | |
| Complete \| | UNTIL_{—} | challenge? FRQ practice is your | | | |
| No FRQ Test | AP_EXAM} | secret weapon for | | | |
| | days left until | {LATEST_ACTIVE COURSE}. | | | |
| | your test | | | | |
| MCQ Test | {DAYS_{—} | Elevate your | | | |
| Complete \| | UNTIL_{—} | {LATEST_ACTIVE_COURSE} | | | |
| No FRQ Test | AP_EXAM} | game with FRQ practice. Let's | | | |
| | days left until | get on the path to success, | | | |
| | your test | {USERNAME}! | | | |
| MCQ Test | Thinking | Our FRQ/MCQ practice tests | | | |
| Complete \| | about the | will though. Spend 15 minutes | | | |
| No FRQ Test | {LATEST | on TeachTap and let us help | | | |
| | ACTIVE | you out. | | | |
| | COURSE} | | | | |
| | exam doesn't | | | | |
| | help. | | | | |
| MCQ Test | IT WORKS! | Studying. We have more short | | | |
| Complete \| | | MCQ and FRQ practice tests | | | |
| No FRQ Test | | just for you. | | | |
| MCQ Test | Reminder: | You have | | | |
| Complete \| | {LATEST | {DAYS_UNTIL AP EXAM} | | | |
| No FRQ Test | ACTIVE | days left. Try out more practice | | | |
| | COURSE} | tests and see if you're ready | | | |
| | is coming! | | | | |
| MCQ Test | You to ok one! | But there's more. Way more | | | |
| Complete \| | | actually. Take a couple | | | |
| No FRQ Test | | {LATEST ACTIVE COURSE} | | | |
| | | practice tests each day to get | | | |
| | | ahead. | | | |

| Student | Title | Body | Deep | | Notification |
|---|---|---|---|---|---|
| Activity State | (max 25 chars) | (max 100 chars) | link | Additional Notes | payload |
| 1. Not | | There are three | | {USERNAME} | |
| finished MCQ | | important | | LATEST_ACTIVE_ | |
| unit test (this | | elements the | | COURSE} | |
| includes users | | notifications | | {DAYS_UNTIL_ | |
| who haven't | | should have: | | AP_EXAM} | |
| started one | | a. Time | | *{HIGHEST_GRADE_ | |
| either) | | pressure-e.g. | | RECEIVED}- | |
| 2. Finished an | | x days left until. . . | | potential field | |
| MCQ unit test | | b. Actionability- | | | |
| but not tried | | specific thing | | | |
| FRQ test | | we want them to | | | |
| 3. Finished | | do-e.g. “it'll | | | |
| MCQ and | | take 5 minutes | | | |
| FRQ test and | | to do a practice | | | |
| did not | | test for unit 1 . . . ” | | | |
| Purchase | | c. Encouragement | | | |
| | | and result-e.g. | | | |
| | | “you can do it”, | | | |
| | | “it's not too | | | |
| | | late”, “spending | | | |
| | | x hours in | | | |
| | | TeachTap can | | | |
| | | increase your | | | |
| | | score from a 4 | | | |
| | | to a 5” | | | |
| No MCQ Test | {DAYS_ | Take a 5-minute | teachtap:// | | { |
| | UNTIL_AP_ | MCQ practice | startunittest? | | “aps”: { |
| | EXAM} | test for Unit 1 | courseId={ | | “content- |
| | days left | right now! | LATEST_ | | available”: 1, |
| | until the | | ACTIVE_ | | “alert”: { |
| | {LATEST_ | | COURSE_ | | “title”: |
| | ACTIVE_ | | ID }&unitId= | | “{DAYS_UNTIL_ |
| | COURSE} | | {UNIT_1_ID} | | AP_EXAM} |
| | test. | | | | days left until the |
| | | | | | {LATEST_ |
| | | | | | ACTIVE_COURSE} |
| | | | | | test.”, |
| | | | | | “body”: |
| | | | | | “Take a 5-minute |
| | | | | | MCQ practice |
| | | | | | test for Unit 1 |
| | | | | | right now!” |
| | | | | | “category”: |
| | | | | | “MainTestScreen” |
| | | | | | }, |
| | | | | | “courseId”: |
| | | | | | “6ec9c7dc-25a8- |
| | | | | | 7ccb-531c- |
| | | | | | d2b0d6c9ae1d”, |
| | | | | | “unitId”: |
| | | | | | “e123c052-c9e7- |
| | | | | | 419a-9f96- |
| | | | | | dc5f53e2b5a8” |
| | | | | | } |
| {USERNAME}, | You have | teachtap://testpr | | { | {USERNAME}, |
| are you | {DAYS_ | ep?courseId={ | | “aps”: { | are you ready for |
| ready for the | UNTIL_AP_ | LATEST_ACTIVE_ | | “content-available”: 1, | the |
| {LATEST_ | EXAM} | COURSE_ID} | | “alert”: { | {LATEST_ACTIVE_ |
| ACTIVE_ | days left. | | | “title”: | COURSE} |
| COURSE} exam? | Try our | | | “{USERNAME}, | exam? |
| | MCQ | | | are you ready for the | |
| | practice | | | {LATEST_ACTIVE_ | |
| | tests! | | | COURSE} | |
| | | | | exam?”, | |
| | | | | “body”: “You have | |
| | | | | {DAYS_UNTIL_ | |
| | | | | AP_EXAM} days | |
| | | | | left. Try our MCQ | |
| | | | | practice tests!” | |
| | | | | }, | |
| | | | | “category”: | |
| | | | | “TestPrepList” | |
| | | | | }, | |
| | | | | “courseId”: | |
| | | | | “6ec9c7dc-25a8- | |
| | | | | 7ccb-531c- | |
| | | | | d2b0d6c9aeld”, | |
| | | | | } | |
| Urgent: AP | {DAYS_ | teachtap://testprep? | | | |
| Prep Needed! | UNTIL_AP_ | courseId={ | | | |
| | EXAM} | LATEST_ | | | |
| | days remain. | ACTIVE_ | | | |
| | Take a short | COURSE_ID} | | | |
| | MCQ practice | | | | |
| | test! | | | | |
| Only | It won't take | teachtap://testprep? | | | |
| {DAYS_UNTIL_ | long to | courseId={ | | | |
| AP_EXAM} | improve | LATEST_ACTIVE_ | | | |
| days. Are | your score | COURSE_ | | | |
| you ready? | with our | ID} | | | |
| | {LATEST_ | | | | |
| | ACTIVE_ | | | | |
| | COURSE} | | | | |
| | practice | | | | |
| | tests. You | | | | |
| | can do it | | | | |
| | {USERNAME}! | | | | |
| Will you pass | It's | teachtap://testprep? | | | |
| your | {DAYS_ | courseId={ | | | |
| {LATEST_ | UNTIL_AP_ | LATEST_ | | | |
| ACTIVE_ | EXAM} | ACTIVE_ | | | |
| COURSE} exam? | days away. | COURSE_ID} | | | |
| | Let our MCQ | | | | |
| | practice | | | | |
| | tests help | | | | |
| | you out. | | | | |
| Crisis Mode: | Time is not | teachtap:// | | | |
| Activated! | your friend. | startunittest?courseId | | | |
| | Outsmart it | ={LATEST_ | | | |
| | with a quick | ACTIVE_ | | | |
| | {LATEST | COURSE_ID} | | | |
| | ACTIVE C | &unitId= | | | |
| | OURSE} | {UNIT_1_ID} | | | |
| | practice test. | | | | |
| | Try it now! | | | | |
| MCQ Test | FRQs! | If that strikes | teachtap:// | | |
| Complete \| No | | fear into your | testprep? | | |
| FRQ Test | | heart, we'll help | courseId= | | |
| | | you figure them | {LATEST_ | | |
| | | out. There are | ACTIVE_ | | |
| | | {DAYS_UNTIL_ | COURSE_ | | |
| | | AP EXAM} | ID} | | |
| | | days until the | | | |
| | | {LATEST_ | | | |
| | | ACTIVE_ | | | |
| | | COURSE} exam. | | | |
| MCQ & FRQ | Unit 1? | Now it's time | MCQ & | | |
| Test | Check! | for the rest. | FRQ Test | | |
| Complete | | Click here for | Complete | | |
| | | more! | | | |
| MCQ & FRQ | Nailed it! | Build up your | MCQ & | | |
| Test | | knowledge | FRQ Test | | |
| Complete | | before the big | Complete | | |
| | | {LATEST_ | | | |
| | | ACTIVE_ | | | |
| | | COURSE} exam. | | | |
| | | It's {DAYS_UNTIL_ | | | |
| | | AP_EXAM} | | | |
| | | days away. | | | |
| | | Don't wait! | | | |
| No MCQ Test | Is | Don't study like | No MCQ | | |
| | {USERNAME} | one! Be a big | Test | | |
| | smarter than | kid and take a | | | |
| | a 5th | 5-minute | | | |
| | Grader? | {LATEST_ | | | |
| | | ACTIVE_COURSE} | | | |
| | | practice test. | | | |
| No MCQ Test | Do you | With only | No MCQ | | |
| | agree? | {DAYS_UNTIL_ | Test | | |
| | | AP_EXAM} | | | |
| | | days left, your | | | |
| | | {LATEST_ | | | |
| | | ACTIVE_COURSE} | | | |
| | | exam should | | | |
| | | be your focus. | | | |
| MCQ Test | Thinking | Our FRQ/MCQ | MCQ | | |
| Complete \| No | about the | practice tests | Test | | |
| FRQ Test | {LATEST | will though. | Complete \| | | |
| | ACTIVE | Spend 15 | No FRQ | | |
| | COURSE} | minutes on | Test | | |
| | exam | Teach Tap and | | | |
| | doesn't help. | let us help you | | | |
| | | out. | | | |

| Course | AI Figure | Video Link | Script | Content Queries |
|---|---|---|---|---|
| AP US | George | PNV_APUSH_ | [Beautiful sunset in the background] | INSERT INTO |
| History | Washington | 2.mp4 | Hello friend, we've been putting off | content_gen_generated_ |
| | | | our plans for too long. Let's study so | content (id, |
| | | | we can finally get that 5 we've been | requested_ |
| | | | talking about. | context, content, |
| | | | | content_generator_ |
| | | | | config_id, |
| | | | | standard_id) |
| | | | | VALUES (UUID( ), |
| | | | | ‘{ }’, ‘{“question”: |
| | | | | “video for AP push |
| | | | | notification”, |
| | | | | “response”: {“text”: |
| | | | | “[Beautiful sunset in |
| | | | | the background] |
| | | | | Hello friend, we've |
| | | | | been putting off our |
| | | | | plans for too long. |
| | | | | Let's study so we |
| | | | | can finally get that 5 |
| | | | | we've been talking |
| | | | | about.”, “video”: |
| | | | | {“url”: |
| | | | | “https://alphacoachbot- |
| | | | | production- |
| | | | | midjourney-images.s3. |
| | | | | amazonaws. |
| | | | | com/production/videos/ |
| | | | | PNV_APUSH_2. |
| | | | | mp4”}, “excuse”: |
| | | | | “”,“speaker”: |
| | | | | {“name”: “George |
| | | | | Washington”, |
| | | | | “image”: {“url”: |
| | | | | “https://alphacoachbot- |
| | | | | production- |
| | | | | midjourney- |
| | | | | images.s3.amazonaws. |
| | | | | com/production/ |
| | | | | images/ciUkEGws61a |
| | | | | WusumTsst_thumbnail. |
| | | | | webp”},“handle”: |
| | | | | “@OGPresidentGW”, |
| | | | | “biography_fun”: |
| | | | | “1st Prez. Founding |
| | | | | Father. Wooden |
| | | | | teeth? Nah! Lover of |
| | | | | liberty and laws, not |
| | | | | a fan of cherry |
| | | | | trees!”, “biography_ |
| | | | | short”: “1st US |
| | | | | President”}, |
| | | | | “appropriate”: |
| | | | | true, “language_style”: |
| | | | | “Modern”}}’, |
| | | | | ‘6d79c1c4-c5b2- |
| | | | | 11ee-8e33- |
| | | | | 0e986e48a3f9’, |
| | | | | ‘c5544f97-6c04- |
| | | | | 11ee-b2e6- |
| | | | | afc1a3dc8172’); |
| AP US | George | PNV_APUSH_ | [Beautiful sunset in the background] | INSERT INTO |
| History | Washington | 2.mp4 | Hello friend, we've been putting off | content_gen_ |
| | | | our plans for too long. Let's study so | generated_content (id, |
| | | | we can finally get that 5 we've been | requested_context, |
| | | | talking about. | content, content_ |
| | | | | generator_config_id, |
| | | | | standard_id) |
| | | | | VALUES (UUID( ), |
| | | | | ‘{ }’, ‘{“question”: |
| | | | | “video for AP push |
| | | | | notification”, |
| | | | | “response”: {“text”: |
| | | | | “[Beautiful sunset in |
| | | | | the background] |
| | | | | Hello friend, we've |
| | | | | been putting off our |
| | | | | plans for too long. |
| | | | | Let's study so we |
| | | | | can finally get that 5 |
| | | | | we've been talking |
| | | | | about.”, “video”: |
| | | | | {“url”: |
| | | | | “https://alphacoachbot- |
| | | | | production- |
| | | | | midjourney- |
| | | | | images.s3.amazonaws. |
| | | | | com/production/videos/ |
| | | | | PNV_APUSH_2. |
| | | | | mp4”}, “excuse”: |
| | | | | “”, “speaker”: |
| | | | | {“name”: “George |
| | | | | Washington”, |
| | | | | “image”: {“url”: |
| | | | | “https://alphacoachbot- |
| | | | | production- |
| | | | | midjourney- |
| | | | | images.s3.amazonaws. |
| | | | | com/production/im |
| | | | | ages/ciUkEGws61a |
| | | | | WusumTsst_thumbn |
| | | | | ail.webp”}, “handle”: |
| | | | | “@OGPresidentGW”, |
| | | | | “biography_fun”: |
| | | | | “1st Prez. Founding |
| | | | | Father. Wooden |
| | | | | teeth? Nah! Lover of |
| | | | | liberty and laws, not |
| | | | | a fan of cherry |
| | | | | trees!”, “biography_ |
| | | | | short”: “1st US |
| | | | | President”}, |
| | | | | “appropriate”: |
| | | | | true, “language_style”: |
| | | | | “Modern”}}’, |
| | | | | ‘6d79c1c4-c5b2- |
| | | | | 11ee-8e33- |
| | | | | 0e986e48a3f9’, |
| | | | | ‘c5544f97-6c04- |
| | | | | 11ee-b2e6- |
| | | | | afc1a3dc8172’); |
| AP US | George | PNV APUSH_ | Do you know how long it takes to dig | INSERT INTO |
| History | Washington | 9.mp4 | an 800-yard trench? Trust me, it's a | content gen_generated_ |
| | | | lot faster to prepare for your AP Exam | content (id, |
| | | | with TeachTap. And a lot less dirty. | requested_context, |
| | | | So dig in! (See FIG. 13) | content, |
| | | | | content generator_c |
| | | | | onfig_id, |
| | | | | standard_id) |
| | | | | VALUES (UUID(), |
| | | | | ‘{ }’, ‘{“question”: |
| | | | | “video for AP push |
| | | | | notification”, “response”: |
| | | | | {“text”: “Do you |
| | | | | know how long it |
| | | | | takes to dig an 800- |
| | | | | yard trench? Trust |
| | | | | me, it's a lot faster to |
| | | | | prepare for your AP |
| | | | | Exam with |
| | | | | TeachTap. And a lot |
| | | | | less dirty. So dig |
| | | | | in!”, “video”: {“url”: |
| | | | | “https://alphacoachbot- |
| | | | | production- |
| | | | | midjourney- |
| | | | | images.s3.amazonaws. |
| | | | | com/production/videos/ |
| | | | | PNV_APUSH_9. |
| | | | | mp4”}, “excuse”: |
| | | | | “”, “speaker”: |
| | | | | {“name”: “George |
| | | | | Washington”, “image |
| | | | | ”: {“url”: |
| | | | | “https://alphacoachbot- |
| | | | | production- |
| | | | | midjourney- |
| | | | | images.s3.amazonaws. |
| | | | | com/production/images/ |
| | | | | ciUkEGws61a |
| | | | | WusumTsst_thumbnail. |
| | | | | webp”}, “handle”: |
| | | | | “@OGPresidentGW”, |
| | | | | “biography_fun”: |
| | | | | “1st Prez. Founding |
| | | | | Father. Wooden |
| | | | | teeth? Nah! Lover of |
| | | | | liberty and laws, not |
| | | | | a fan of cherry |
| | | | | trees!”, “biography_ |
| | | | | short”: “1st US |
| | | | | President”}, |
| | | | | “appropriate”: |
| | | | | true,“language_style”: |
| | | | | “Modern”}}’, |
| | | | | ‘6d79c1c4-c5b2- |
| | | | | 11ee-8e33- |
| | | | | 0e986e48a3f9’, |
| | | | | ‘c5544f97-6c04- |
| | | | | 11ee-b2e6- |
| | | | | afc1a3dc8172’); |
| AP World | Genghis | PNV_APW_ | I command you to finish your lessons | INSERT INTO |
| History | Khan | 2.mp4 | at once. I do this as a helpful AI tutor | content_gen_generated_ |
| | | | and possibly as a loving distant | content (id, |
| | | | relative of yours. | requested_context, |
| | | | | content, |
| | | | | content_generator_ |
| | | | | config_id, |
| | | | | standard_id) |
| | | | | VALUES (UUID( ), |
| | | | | ‘{ }’, ‘{“question”: |
| | | | | “video for AP push |
| | | | | notification”, “response”: |
| | | | | {“text”: “I |
| | | | | command you to |
| | | | | finish your lessons at |
| | | | | once. I do this as a |
| | | | | helpful AI tutor and |
| | | | | distant relative of |
| | | | | yours.”, “video”: |
| | | | | {“url”: |
| | | | | “https://alphacoachbot- |
| | | | | production- |
| | | | | midjourney- |
| | | | | images.s3.amazonaws. |
| | | | | com/production/videos/ |
| | | | | PNV_APW_2.mp4”}, |
| | | | | “excuse”: |
| | | | | “”, “speaker”: |
| | | | | {“name”: “Genghis |
| | | | | Khan”, “image”: |
| | | | | {“url”: |
| | | | | “https://alphacoachbot- |
| | | | | production- |
| | | | | midjourney- |
| | | | | images.s3.amazonaws. |
| | | | | com/production/ |
| | | | | images/jn95ALfVE7w9 |
| | | | | iqUsua8X_thumbnail. |
| | | | | webp”}, “handle”: |
| | | | | “@GreatKhan”, “biography_ |
| | | | | fun”: “Leader |
| | | | | of the Mongol |
| | | | | Empire, we ride |
| | | | | together, we conquer |
| | | | | together!”, “biography_ |
| | | | | short”: “Mongol |
| | | | | Empire Founder”}, |
| | | | | “appropriate”: |
| | | | | true, “language_style |
| | | | | ”: “Modern”}}’, |
| | | | | ‘6d79c1c4-c5b2- |
| | | | | 11ee-8e33- |
| | | | | 0e986e48a3f9’, |
| | | | | ‘c5544f97-6c04- |
| | | | | 11ee-b2e6- |
| | | | | afcla3dc8172’); |
| AP | Jane | PNV_APES_ | Not all animals can be domesticated. | INSERT INTO |
| Environmental | Goodall | 16.mp4 | You're a tough one, aren't you? But | content gen_generated_ |
| Science | | | in here we will tame even the wildest | content (id, |
| | | | AP exam. | requested_context, |
| | | | | content, |
| | | | | content_generator_ |
| | | | | config_id, |
| | | | | standard_id) |
| | | | | VALUES (UUID( ), |
| | | | | ‘{ }’, ‘{“question”: |
| | | | | “video for AP push |
| | | | | notification”, “response”: |
| | | | | {“text”: “Not all |
| | | | | animals can be |
| | | | | domesticated. |
| | | | | You're a tough one, |
| | | | | aren't you? But in |
| | | | | here we will tame |
| | | | | even the wildest AP |
| | | | | exam.”, “video”: |
| | | | | {“url”: |
| | | | | “https://alphacoachbot- |
| | | | | production- |
| | | | | midjourney- |
| | | | | images.s3.amazonaws. |
| | | | | com/production/videos/ |
| | | | | PNV_APES 16. |
| | | | | mp4”}, “excuse”: |
| | | | | “”, “speaker”: |
| | | | | {“name”: “Jane |
| | | | | Goodall”, “image”: |
| | | | | {“url”: |
| | | | | “https://alphacoachbot- |
| | | | | production- |
| | | | | midjourney- |
| | | | | images.s3.amazonaws. |
| | | | | com/production/images/ |
| | | | | EdZKtWx13pv |
| | | | | KwzCOdagF_thumb |
| | | | | nail.webp”}, “handle”: |
| | | | | “@JungleJaneG”, |
| | | | | “biography_fun”: |
| | | | | “Chimp's best friend. |
| | | | | Breaking barriers & |
| | | | | understanding |
| | | | | primate behavior in the |
| | | | | wild.”, “biography_ |
| | | | | short”: “Chimpanzee |
| | | | | Expert”}, “appropriate″: |
| | | | | true, “language_style”: |
| | | | | “Modern”}}’, |
| | | | | ‘6d79c1c4-c5b2- |
| | | | | 11ee-8e33- |
| | | | | 0e986e48a3f9’, |
| | | | | c5544f97-6c04- |
| | | | | 11ee-b2e6- |
| | | | | afc1a3dc8172’); |
| AP European | Queen | APEURO_ | It has been a hard fought battle, but I | INSERT INTO |
| History | Elizabeth I | 17.mp4 | see my notifications have breached | content_gen_generated_ |
| | | | your defenses. Let us end this | content (id, |
| | | | squabble. Come study for your AP | requested_context, |
| | | | exams, or prepare for war. | content, |
| | | | | content generator_ |
| | | | | config_id, |
| | | | | standard_id) |
| | | | | VALUES (UUID( ), |
| | | | | ‘{ }’, ‘{“question”: |
| | | | | “video for AP push |
| | | | | notification”, “response”: |
| | | | | {“text”: “It has |
| | | | | been a hard fought |
| | | | | battle, but I see my |
| | | | | notifications have |
| | | | | breached your |
| | | | | defenses. Let us end |
| | | | | this squabble. Come |
| | | | | study for your AP |
| | | | | exams, or prepare for |
| | | | | war.”, “video”: |
| | | | | {“url”: |
| | | | | “https://alphacoachbot- |
| | | | | production- |
| | | | | midjourney- |
| | | | | images.s3.amazonaws. |
| | | | | com/production/vid |
| | | | | eos/APEURO_17. |
| | | | | mp4”}, “excuse”: |
| | | | | “”, “speaker”: |
| | | | | {“name”: “Queen |
| | | | | Elizabeth I”, “image”: |
| | | | | {“url”: |
| | | | | “https://alphacoachbot- |
| | | | | production- |
| | | | | midjourney- |
| | | | | images.s3.amazonaws. |
| | | | | com/production/images/ |
| | | | | zz0qHBCKNijs |
| | | | | FonkOQFQ_thumbnail. |
| | | | | webp”}, “handle”: |
| | | | | “@thevirginqueen”, |
| | | | | “biography_fun”: |
| | | | | “Virgin queen ruling |
| | | | | a Protestant England. |
| | | | | Making ruffs, plays |
| | | | | and sailors cool since |
| | | | | 1558”, |
| | | | | “biography_short”: |
| | | | | “Virgin Queen”}, |
| | | | | “appropriate”: |
| | | | | true, “language_style”: |
| | | | | “Modern”}}’, |
| | | | | ‘6d79c1c4-c5b2- |
| | | | | 11ee-8e33- |
| | | | | 0e986e48a3f9’, |
| | | | | ‘c5544f97-6c04- |
| | | | | 11ee-b2e6- |
| | | | | afc1a3dc8172’); |
| AP European | Queen | PNV_APEURO_ | Loyal subject! Your queen commands | INSERT INTO |
| History | Elizabeth I | 20.mp4 | you to conquer the AP Euro exam | content_gen generated_ |
| | | | with TeachTap! | content (id, |
| | | | Prove your worth, or face the shame | requested_context, |
| | | | of failure and my royal wrath! | content, |
| | | | Your future and your queen demand | content_generator_ |
| | | | it! | config_id, |
| | | | | standard_id) |
| | | | | VALUES (UUID( ), |
| | | | | ‘{ }’, ‘{“question”: |
| | | | | “video for AP push |
| | | | | notification”, “response”: |
| | | | | {“text”: “Loyal |
| | | | | subject! Your queen |
| | | | | commands you to |
| | | | | conquer the AP Euro |
| | | | | exam with |
| | | | | TeachTap! |
| | | | | Prove your worth, or |
| | | | | face the shame of |
| | | | | failure and my royal |
| | | | | wrath! |
| | | | | Your future and your |
| | | | | queen demand |
| | | | | it!”, “video”: {“url”: |
| | | | | “https://alphacoachbot- |
| | | | | production- |
| | | | | midjourney- |
| | | | | images.s3.amazonaws. |
| | | | | com/production/videos/ |
| | | | | PNV_APEURO20. |
| | | | | mp4”}, “excuse”: |
| | | | | “”, “speaker”: |
| | | | | {“name”: “Queen |
| | | | | Elizabeth I”, |
| | | | | “image”: {“url”: |
| | | | | “https://alphacoachbot- |
| | | | | production- |
| | | | | midjourney- |
| | | | | images.s3.amazonaws. |
| | | | | com/production/images/ |
| | | | | zz0qHBCKNijs |
| | | | | FonkOQFQ_thumbnail. |
| | | | | webp”}, “handle”: |
| | | | | “@thevirginqueen”, |
| | | | | “biography_fun”: |
| | | | | “Virgin queen ruling |
| | | | | a Protestant England. |
| | | | | Making ruffs, plays |
| | | | | and sailors cool since |
| | | | | 1558”, |
| | | | | “biography_short”: |
| | | | | “Virgin Queen”}, |
| | | | | “appropriate”: |
| | | | | true, “language_style”: |
| | | | | “Modern”}}’, |
| | | | | ‘6d79c1c4-c5b2- |
| | | | | 11ee-8e33- |
| | | | | 0e986e48a3f9’, |
| | | | | ‘c5544f97-6c04- |
| | | | | 11ee-b2e6- |
| | | | | afc1a3dc8172’); |
| AP | Adam | PNV_APMACRO_ | Those who score fives on their AP | INSERT INTO |
| Macroeconomics | Smith | 12.mp4 | exams climb to the top of the | content_gen_generated_ |
| | | | pyramid. Where they laugh, get into | content (id, |
| | | | great schools, and sometimes scheme. | requested_context, |
| | | | Get it? You will. Learn all things AP | content, |
| | | | Macro with me, Adam Smith. | content_generator_ |
| | | | | config_id, |
| | | | | standard_id) |
| | | | | VALUES (UUID( ), |
| | | | | ‘{ }’, ‘{“question”: |
| | | | | “video for AP push |
| | | | | notification”, “response”: |
| | | | | {“text”: “Those |
| | | | | who score fives on |
| | | | | their AP exams |
| | | | | climb to the top of |
| | | | | the pyramid. Where |
| | | | | they laugh, get into |
| | | | | great schools, and |
| | | | | sometimes scheme. |
| | | | | Get it? You will. |
| | | | | Learn all things AP |
| | | | | Macro with me, Adam |
| | | | | Smith.”, “video”: |
| | | | | {“url”: |
| | | | | “https://alphacoachb |
| | | | | production-ot- |
| | | | | midjourney- |
| | | | | images.s3.amazonaws. |
| | | | | com/production/videos/ |
| | | | | PNV_APMACRO_ |
| | | | | 12.mp4”}, “excuse″: |
| | | | | “”, “speaker”: |
| | | | | {“name”: “Adam |
| | | | | Smith”, “image”: |
| | | | | {“url”: |
| | | | | “https://alphacoachbot- |
| | | | | production- |
| | | | | midjourney- |
| | | | | images.s3.amazonaws. |
| | | | | com/production/images/ |
| | | | | jICmijIoPyAxP |
| | | | | tMUzA5L_thumbnail. |
| | | | | webp”},“handle”: |
| | | | | “@Wealthy_of Nations”, |
| | | | | “biography_fun |
| | | | | ”: “Musing on |
| | | | | invisible hands and |
| | | | | debunking |
| | | | | mercantilism since |
| | | | | 1776! |
| | | | | #EconomistLife”, |
| | | | | “biography_short”: |
| | | | | “Wealth of Nations |
| | | | | Author”}, “appropriate”: |
| | | | | true, “language_style”: |
| | | | | “Modern”}}’, |
| | | | | ‘6d79c1c4-c5b2- |
| | | | | 11ee-8e33- |
| | | | | 0e986e48a3f9’, |
| | | | | ‘c5544f97-6c04- |
| | | | | 11ee-b2e6- |
| | | | | afcla3dc8172’); |
| AP | Adam | PNV_APMACRO_ | AP exams, like our own currency, is | INSERT INTO |
| Macroeconomics | Smith | 16.mp4 | being printed as fast as the machines | content_gen generated_ |
| | | | can run! So tap in now and study with | content (id, |
| | | | me-faster than their ink can dry. | requested_context, |
| | | | Together we'll get a perfect 5. | content, |
| | | | | content_generator_c |
| | | | | onfig_id, |
| | | | | standard_id) |
| | | | | VALUES (UUID( ), |
| | | | | ‘{ }’, ‘{“question”: |
| | | | | “video for AP push |
| | | | | notification”, “response”: |
| | | | | {“text”: “AP |
| | | | | exams, like our own |
| | | | | currency, is being |
| | | | | printed as fast as the |
| | | | | machines can run! |
| | | | | So tap in now and |
| | | | | study with me- |
| | | | | faster than their ink |
| | | | | can dry. Together |
| | | | | we'll get a perfect 5.”, |
| | | | | “video”: {“url”: |
| | | | | “https://alphacoachbot- |
| | | | | production- |
| | | | | midjourney- |
| | | | | images.s3.amazonaws. |
| | | | | com/production/videos/ |
| | | | | PNV_APMACRO_ |
| | | | | 16.mp4”},“excuse”: |
| | | | | “”, “speaker”: |
| | | | | {“name”: “Adam |
| | | | | Smith”, “image”: |
| | | | | {“url”: |
| | | | | “https://alphacoachbot- |
| | | | | production- |
| | | | | midjourney- |
| | | | | images.s3.amazonaws. |
| | | | | com/production/images/ |
| | | | | jICmijIoPyAxP |
| | | | | tMUzA5L thumbnail. |
| | | | | webp”}, “handle”: |
| | | | | “@Wealthy_of_Nations”, |
| | | | | “biography_fun”: |
| | | | | “Musing on |
| | | | | invisible hands and |
| | | | | debunking |
| | | | | mercantilism since |
| | | | | 1776! |
| | | | | “EconomistLife”, |
| | | | | “biography_short”: |
| | | | | “Wealth of Nations |
| | | | | Author”}, “appropriate”: |
| | | | | true, “language_style”: |
| | | | | “Modern”}}’, |
| | | | | ‘6d79c1c4-c5b2- |
| | | | | 11ee-8e33- |
| | | | | 0e986e48a3f9’, |
| | | | | ‘c5544f97-6c04- |
| | | | | 11ee-b2e6- |
| | | | | afc1a3dc8172’); |

| Student | | |
|---|---|---|
| Activity | | |
| State | Title (max 25 chars) | Body (max 100 chars) |
| 1. Not | | There are three important elements the notifications should |
| finished | | have: [symbol] [symbol] |
| MCQ | | b. Actionability-specific thing we want them to do-e.g. “it'll |
| unit test | | take x minutes to do a practice test” |
| (this | | c. Encouragement and result-e.g. “you can do it”, “it's not too |
| includes | | late”, “spending x hours in TeachTap can increase your SAT |
| users who | | score by x points” |
| haven't | | |
| started | | |
| one | | |
| either) | | |
| 2. Finished | | |
| an MCQ | | |
| unit test | | |
| but not | | |
| tried | | |
| FRQ test | | |
| 3. Finished | | |
| MCO | | |
| and FRQ | | |
| test and | | |
| did not | | |
| purchase | | |

| Course | AI Figure | Video Link | Script |
|---|---|---|---|
| AP US | George | APNV_APUSH_ | Want to increase your AP score? Here's the |
| History | Washington | 1.mp4 | recipe: discipline, perseverance, and TeachTap! |
| | | | Study APUSH for 5 to 10 hours and amend your |
| | | | score by an entire point. |
| AP US | George | APNV_APUSH_ | It took me 10 days just to get from Virginia to |
| History | Washington | 2.mp4 | New York! But you can spend just 5 to 10 |
| | | | HOURS studying to raise your AP Exam score |
| | | | by an entire point? That doesn't seem fair at all. |
| AP US | Thurgood | SA_PNV_9.mp4 | The first AP test administered this year is AP US |
| Government | Marshall | | Government. That means you have less time |
| | | | than everyone else to prepare for your test. Test |
| | | | Prep can help expedite your studying. Spend as |
| | | | little as one hour per unit in Test Prep and see |
| | | | your AP score improve by an entire point. Good |
| | | | luck on the test! |
| AP US | Thurgood | PNV_APGOV_ | As a lawyer, I knew preparation was key to |
| Government | Marshall | qb1.mp4 | winning a case. The same goes for your AP |
| | | | exam. With 5 to 10 hours of studying on |
| | | | TeachTap, you can increase your score by an |
| | | | entire point! So go on, make me proud! |
| AP | Ivan Pavlov | PNV_APPSYCH_ | If imagining your AP Exam score makes you |
| Psychology | | qb1.mp4 | cringe, that's a conditioned response. But it can |
| | | | be reversed. Spending one hour per unit in test |
| | | | prep can increase your score by an entire point. |
| | | | Start getting better results, and drive that cringe |
| | | | into extinction. |
| AP | Ivan Pavlov | SA_PNV_8.mp4 | Did you know inactive forms of studying such as |
| Psychology | | | reviewing old notes or watching solutions to |
| | | | previous year's exams trick your brain into |
| | | | thinking? Take an active approach to studying |
| | | | with Test Prep. Solve realistic AP problems |
| | | | under simulated timed conditions and with as |
| | | | little as an hour per unit, you can improve your |
| | | | AP score by an entire point or more. Happy |
| | | | studying! |

Notes
• In 5-10 hours of TeachTap you can increase your score by an entire point
• Spending 1 hour per unit in Test Prep can increase your score by an entire point 48-hour cram plan.
• 5-10 hours of studying in TeachTap can raise your SAT score by 50 points

| Student | | | |
|---|---|---|---|
| State | Cohort | Title (max 25 chars) | Body (max 100 chars) |
| | 1. Not | | There are three important elements the |
| | finished | | notifications should have: |
| | MCQ unit | | [symbol] [symbol] |
| | test (this | | b. Actionability-specific thing we want them to |
| | includes | | do-e.g. “it'll take x minutes to do a practice |
| | users who | | test” |
| | haven't | | c. Encouragement and result-e.g. “you can do |
| | started one | | it”, “it's not too late”, “spending x hours in |
| | either) | | TeachTap can increase your SAT score by x |
| | 2. Finished | | points” |
| | an MCQ | | |
| | unit test but | | |
| | not tried | | |
| | FRQ test | | |
| | 3. Finished | | |
| | MCQ and | | |
| | FRQ test | | |
| | and did not | | |
| | purchase | | |
| All | Prepare or | The SAT doesn't | |
| | Perish! | take prisoners. | |
| | | Control your fate | |
| | | with a 20-minute | |
| | | practice test. | |
| All | {USERNAME}, | It's the for college | |
| | are you ready | acceptance and | |
| | for the SAT? | scholarships. | |
| All | SAT Prep | Boost your SAT | |
| | Needed! | score by 50 points | |
| | | with only 5-10 | |
| | | hours of studying. | |
| All | Boost your | It only takes 5-10 | |
| | SAT score | hours, so get started | |
| | by 50+ | now! | |
| | points | | |
| All | Get into a | Crush your SAT. | |
| | good school. | We're ready. Let's | |
| | | make it happen. | |
| All | The | Trust me | |
| | ultimate | {USERNAME}, | |
| | cheat code | unlimited timed | |
| | to a 1600! | practice tests are | |
| | | your key to a 1600 | |
| | | on the SAT. | |
| All | This isn't | Our SAT practice | |
| | forbidden | tests await. Come | |
| | knowledge! | get them! | |
| All | Crisis | Time is not your | |
| | mode: | friend. Outsmart it | |
| | activated! | with a quick SAT | |
| | | practice test. Try it | |
| | | now! | |
| All | Major to a | Use our SAT | |
| | 1600. | practice tests. | |
| | | They're short and | |
| | | convenient. You | |
| | | could start one | |
| | | RIGHT NOW! | |
| All | Do you like | High SAT scores | |
| | money? | are the key to most | |
| | | college scholarships. | |
| All | Psst . . . you | Sneak in here, we | |
| | want a high | have SAT practice | |
| | SAT score? | questions. | |
| All | Predict | You control your | |
| | your SAT | future, but our 20- | |
| | score. | minute practice | |
| | | tests will predict | |
| | | your SAT score. | |
| All | We talking | You have to show | |
| | about | up. Crush the SAT | |
| | practice! | with our 20-minute | |
| | | practice tests. | |
| All | Can you | 5-10 hours in | |
| | break a | TeachTap can boost | |
| | 1400? | your SAT score by | |
| | | 50 points! | |
| All | Easy gains | Invest 5-10 hours | |
| | await! | and you can gain | |
| | | 50+ points on your | |
| | | SAT. | |

The AI prompt can reference the notifications from a data source, such as a spreadsheet containing the exemplary information above.

The codes and functions mentioned in the pseudo-code of the notification generation system 100 is explained below in correspondence to the above mentioned details.

The ‘generate_video_message’ function aims to enhance user motivation by creating personalized video messages from AI teachers. It begins by selecting an appropriate real-time tutor for the user's course using the ‘select ai_teacher’ function. Then, it uses AI engine 124 to generate a customized message script in correspondence to the user and their course via ‘genai_generate_message_script’. This script is utilized to create a video message featuring the real-time tutor's avatar through the ‘create_video_message’ function. Finally, the video message is delivered to the user using ‘deliver_video_message’. This personalized approach is intended to create curiosity and excitement, thereby encouraging the user to remain engaged with their studies and prepare effectively for their exams.

In operation 210, a notification module 132 shares the notification with the user having real-time virtual characters integrated within the message. The virtual character interacts with the user and tries to motivate and retain the user in the online learning platform 102.

The AI engine 124 includes a video message generator 128 and an integrator 130, which helps in generating a video notification. The video message generator 128 employs AI natural language processing (NLP) techniques to create video messages where a virtual character, relevant to educational content, is seamlessly integrated using an integrator component using the integrator 130. This ensures that the virtual character aligns closely with the educational context, providing personalized and engaging content in correspondence to the user's learning needs. Once the video message is generated, complete with the virtual character and its scripted dialogue, it is then transferred to the notification module 132, which handles the delivery of the video notification message to the user, ensuring that the educational content and the character's interaction effectively motivate and support the user's learning experience within the online learning platform 102.

For instance, when the video message generator 128 creates a video message for a student, the notification module 132 takes this message and prepares it for delivery to the student's device. This video notification features a virtual character, such as a real-time tutor, who interacts with the student through personalized messages. These messages are crafted to be motivating and encouraging, addressing the student's specific needs and progress in their studies.

Once the video notification is ready, the notification module delivers 132 of them directly to the student's device, whether it's a smartphone, tablet, or computer. The virtual character within the video engages with the student dynamically, offering encouragement, study tips, and reminders tailored to the student's learning journey. This personalized interaction is aimed at keeping the student motivated and engaged with the online learning platform. By providing real-time, customized messages, the notification module helps retain the student within the learning environment, ensuring they remain on track with their educational goals.

The notification module 132 is designed to provide personalized and timely engagement for users of the online learning platform 102. For example, if a student named Alex has an upcoming exam in AP U.S. History, the notification generation system 100 will generate notifications in correspondence to Alex's specific study needs. Initially, the notification module 132 sends a video notification that includes a motivational message relevant to Alex's coursework and a deep link that directs him to practice tests and study materials related to AP U.S. History. This deep link facilitates quick access to the most pertinent content, helping Alex prepare efficiently for his exam.

If Alex does not interact with the online learning platform 102 for 24 hours, the notification module 132 triggers a text message notification. This message includes a reminder to continue studying and another deep link that redirects him to a unit he struggled with previously. This ensures that Alex can immediately focus on areas that need improvement while being on the learning platform 102.

If Alex remains inactive for another 24 hours, for a total inactivity period of 48 hours, the notification module 132 escalates its engagement efforts by sending a video message. This video features a virtual AI teacher who provides encouragement and specific study tips for AP U.S. History. The notification module 132 will continue to send these video messages every 24 hours of inactivity to keep Alex motivated and engaged.

To maintain relevance and avoid redundancy, a monitoring module 140 analyzes user details and engagement data every 15 minutes. For instance, if Alex logs in and interacts with the online learning platform 102 after receiving a notification, the inactivity timer resets, and no additional notifications will be sent until another period of inactivity is detected. This prevents Alex from receiving unnecessary reminders and ensures that each notification is timely and pertinent.

Moreover, the user can customize the notification settings to match the preferences. The user can choose how often he receives notifications and specify the types of content he finds most useful. For example, Alex might prefer more frequent text reminders closer to his exam date but fewer video messages if he feels those are less necessary. This customization ensures that the notification generation system 100 supports Alex's study habits and keeps him engaged in a manner that suits his individual needs.

The notification module 132 is operatively coupled to a user interface of the online learning place 102 via, a scheduler 134. The notifications shared with the user are received on the user's device and the video message opens up on the user interface 102 of the online learning platform 102. The Scheduler 134 is designed to synchronize with external calendars and scheduling tools to align notifications with the user's overall schedule. By integrating with various calendar applications, scheduler 134 can access the user's planned activities, exam schedules, and daily schedules, ensuring that notifications are sent at the most appropriate times. This synchronization helps avoid conflicts with other events and maximizes the chances of the user engaging with the notifications, thereby enhancing the effectiveness of the personalized reminders and study prompts.

The notification generation system 100 further comprises a monitoring module 140 operatively coupled to the AI engine 124 and is responsible for tracking user activity on the online learning platform 102. The monitoring module 140 continuously monitors user interactions, such as logging in, accessing study materials, or participating in quizzes. Upon detecting any user activity, the monitoring module 140 resets inactivity timers, ensuring that the user's current engagement level is accurately reflected. This dynamic tracking helps the notification module 132 to timely and appropriately prompt the user, avoiding unnecessary notifications when the user is already active on the online learning platform 102.

Additionally, the monitoring module 140 maintains a comprehensive record of all sent notifications and video messages. This record-keeping function helps prevent repetition and ensuring that users receive a diverse range of motivational content. By keeping track of previously sent messages, the notification module 132 can avoid sending the same notification or video multiple times, which could lead to user fatigue and decreased engagement. Instead, the monitoring module 140 ensures that each interaction feels fresh and relevant, thereby maintaining the user's interest and motivation to continue their studies.

The AI engine 124 includes a feedback loop 136 designed to collect user responses and engagement data after they view the video notifications. This feedback loop 136 gathers detailed information on how users interact with the notifications, such as whether they watched the entire video, their engagement with the suggested study materials, and any direct feedback they may provide. By analyzing this data, the prompt generator 122 can refine future prompts and adjust notification timings to better suit user's preferences and behaviors. This continuous refinement ensures that the notifications remain effective and relevant, enhancing the overall user experience and promoting consistent engagement with the online learning platform 102.

The pseudo-code for the notification generation system 100 for retaining users enrolled in an online learning platform 102 is given below:

# Pseudo-code for personalized notifications and video messages from AI teachers

```
# Function to schedule personalized notifications
def schedule_personalized_notifications(user_id, exam_date):
  # Calculate the number of days until the exam
  days_until_exam = calculate_days_until_exam(exam_date)
  # Check the user's activity and goals
  user_goals = get_user_goals(user_id)
  user_activity = get_user_activity(user_id)
  # Determine the type of notification based on user activity and goals
  notification_type = determine_notification_type(user_goals, user_activity)
  # Schedule the notification
  notification_time = calculate_optimal_notification_time(days_until_exam)
  schedule_notification(user_id, notification_type, notification_time)
  # Comments: This function calculates the days until the user's exam and schedules a
notification
  # based on the user's goals and activity. The notification is intended to motivate the
user to return
  # to the app and engage in activities that align with their study goals.
# Function to generate video messages from AI teachers
def generate_video_message(user_id, course_id):
  # Select the relevant AI teacher based on the course
  ai_teacher = select_ai_teacher(course_id)
  # Generate a personalized message script using GenAI
  message_script = genai_generate_message_script(user_id, course_id)
  # Create a video message using the script and AI teacher's avatar
  video_message = create_video_message(ai_teacher, message_script)
  # Deliver the video message to the user
  deliver_video_message(user_id, video_message)
  # Comments: This function selects an AI teacher based on the user's course and
generates a
  # personalized video message using GenAI. The message is designed to create
curiosity and
  # excitement, motivating the user to continue studying for their upcoming exam.
# References to the codebase (contextual information)
# get_user_ goals and get_user_activity are referenced from the context's main use cases
for notifications
# select_ai_teacher and genai_generate_message_script are referenced from the context's
AI tutor features
# create_video_message and deliver_video_message are part of the video messages
novelty described in the context
```

In an embodiment, the notification generation system 100 for retaining users enrolled in an online learning platform 102 the AI engine 124 is equipped to personalize the tone and style of video messages according to user preferences, accommodating variations from formal to informal approaches. For example, if a user prefers a more formal communication style for educational content, the AI engine 124 adjusts the language, and delivery of the virtual character in the video message accordingly. Conversely, for users who respond better to a casual or friendly tone, the AI engine 124 modifies the video's content to align with these preferences. This customization ensures that each video message resonates with the user's style and enhances engagement by delivering content in a manner that is both relatable and effective.

In another embodiment, the notification generation system 100 for retaining users enrolled in an online learning platform 102 utilizes machine learning algorithms to predict optimal study materials based on user data, the process involves several key steps. Initially, user past performance data 112, including scores and engagement metrics such as online learning session duration and educational content access frequency, is collected. These data points provide a comprehensive view of how users interact with educational content over time.

Next, relevant features are extracted from this collected data. These features could include specific scores achieved in tests or assignments, the duration of online learning sessions, and how frequently users access different educational materials. These features serve as inputs for training a machine learning module 138, integrated within the AI engine 124 and designed to uncover patterns and correlations within the data.

The machine learning module 138 undergoes training using the extracted features to distinguish meaningful relationships between user engagement behaviors and improvements in performance. This training allows the machine learning module 138 to learn from past data and develop predictive capabilities that can anticipate how different types of user engagement correlate with learning outcomes.

Once trained, the machine learning module 138 is deployed to predict the optimal educational content for each user based on their current performance levels and engagement patterns. This prediction aims to recommend study materials that are most likely to enhance the user's performance by focusing on areas of weakness and reinforcing strengths. For instance, if a user consistently struggles with specific topics but shows strong engagement with related content, the machine learning module 138 may recommend targeted materials designed to address those weaknesses effectively.

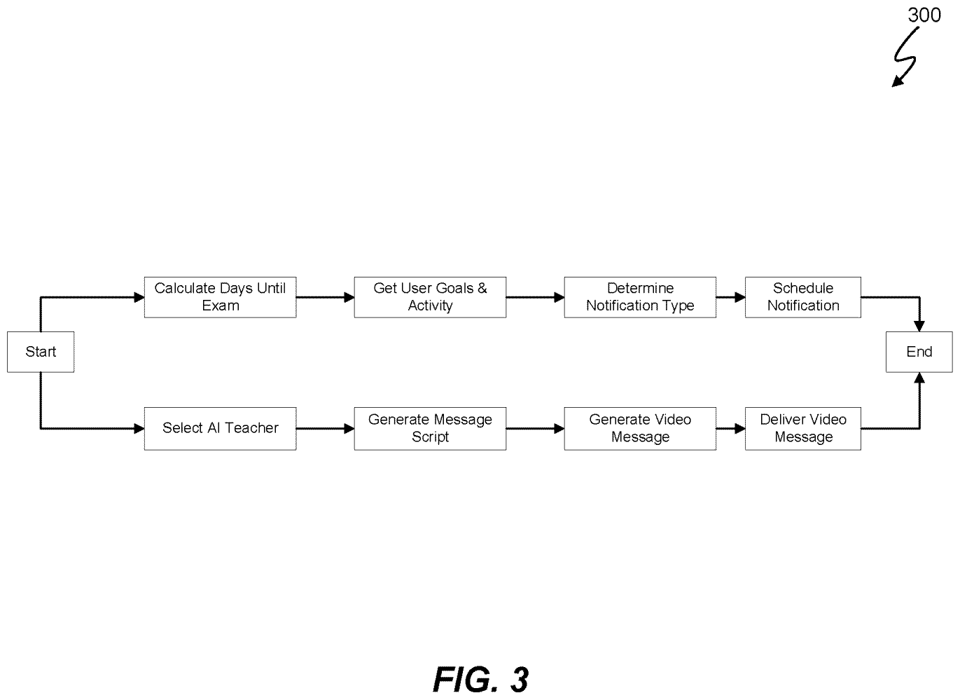

FIG. 3 depicts a flow diagram 300 showing the steps involved in generating and sharing notifications to the users enrolled in an online learning platform 102 to retain them.

The flowchart 300 illustrates the enhancement and re-engagement of the users within the online learning platform 102 by sending AI-generated notifications to the users featuring the real-time tutor.

Initially, the number of days is calculated until a user's exam is scheduled. This ensures that notifications are strategically timed to align with the user's exam schedule, optimizing their preparation efforts. Next, the notification generation module 114 (not shown in the figure) retrieves and analyzes user data, including user profile details 108 like study goals, user engagement data 110, and user performance data 112 within the online learning platform 102. This information is crucial in determining the type of notification whether a text-based message or a more engaging video message featuring the real-time tutor.

The decision-making also involves scheduling notifications based on the user's engagement patterns, ensuring they receive timely prompts without overwhelming them. This scheduling mechanism maintains user interest and encourages consistent interaction with the online learning platform 102. Further, the appropriate real-time tutor avatar is selected and a personalized script for the video message is generated. The real-time tutor is integrated into the video message. This step utilizes natural language processing (NLP) techniques in correspondence to the message content based on the user's study progress and goals, making the interaction more relevant and motivating.

Finally, the video message, featuring the real-time tutor and personalized content, is delivered to the user's device which aims to provide a sense of interaction and encouragement, utilizing the real-time tutor's presence to provide guidance and support in the user's learning journey.

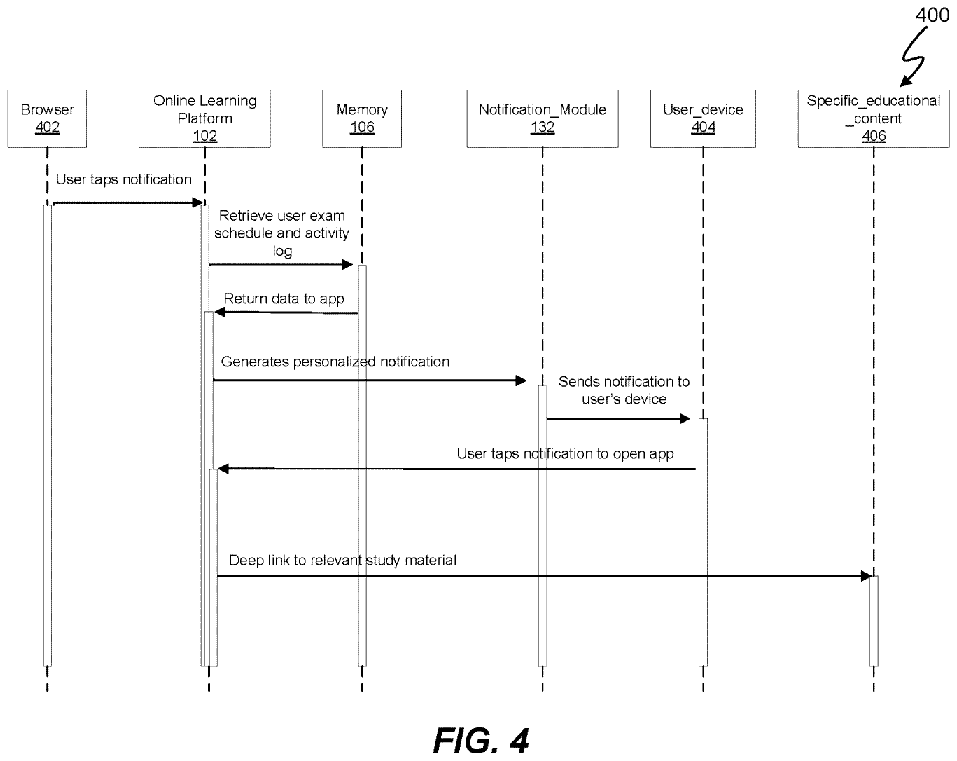

FIG. 4 depicts a deep link containing educational content providing process 400 to the user when the user goes through the notification, which is an embodiment of the notification generation process 200 for retaining users enrolled in an online learning platform 102 of FIG. 2.

The deep link containing educational content providing process 400 illustrates the interactions between various components when a user engages with a notification from an online learning platform 102. The deep link containing educational content providing process 400 begins when the user taps on a notification in their browser 402. This action prompts the online learning platform 102 to communicate with its memory 106, retrieving the user's exam schedule and activity log to ensure the most current and relevant data is being used.

Once the memory 106 retrieves and returns this information to the online learning platform 102, the online learning platform 102 utilizes this data to instruct the notification module 132 to generate a personalized notification featuring a real-time tutor. This notification is in correspondence to the user's specific study needs, taking into account their upcoming exams and past engagement with the educational content.

The personalized notification is then sent to the user's device 504 by the notification module 132. When the user receives and taps on this notification, the online learning platform 102 is re-engaged. The online learning platform 102 responds by directing the user through a deep link to specific educational content 506 that is most relevant to the user's current study requirements. This targeted educational content 506 is designed to help the user effectively prepare for their exams by focusing on areas that need improvement.

The sequence diagram 400 will be clearer with the help of the following example where a high school student named Alex, who has an AP Biology exam scheduled for May 15th, interacts with the online learning platform 102. On May 1st, the online learning platform 102 proactively sent Alex a notification reminding them to review a specific unit on cellular respiration, a topic they previously struggled with. This notification is generated to focus Alex's study efforts on their weaker areas, thereby optimizing their preparation time.

When Alex taps the notification, the sequence 400 initiates a series of interactions. First, the online learning platform 102 communicates with the memory 106 to retrieve Alex's exam schedule and activity log. This step ensures that the online learning platform 102 has the latest information about Alex's upcoming exams and past study activities. Memory 106 responds by returning the relevant data to the online learning platform 102.

Next, the online learning platform 102 uses this data to generate a personalized notification through the notification module 132 which is responsible for creating a message that reports Alex's specific study needs and schedules. Once the personalized notification is ready, it is sent to Alex's device 504.

Upon receiving the notification on their device, Alex taps on it to open the online learning platform 102. This action triggers a deep link within the online learning platform 102 that directs Alex straight to the relevant educational content 506, specifically a practice test for the unit on cellular respiration. This targeted online learning platform 102 not only reminds Alex of the upcoming exam but also immediately provides them with the tools to reinforce their understanding of a challenging topic.

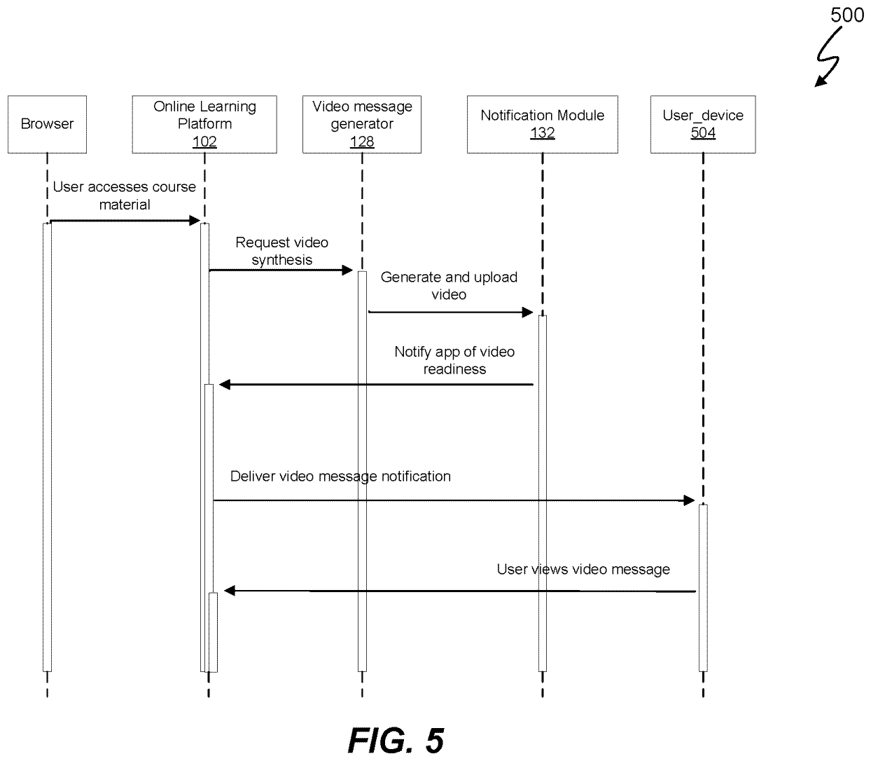

FIG. 5 depicts a notification delivery process 500, which is an embodiment of the notification generation process 200 for retaining users enrolled in an online learning platform 102 of FIG. 2. The notification delivery process 500 illustrates the generation and delivery of a personalized video message to a user within an online learning platform 102. Initially, the user accesses educational content through the browser 502, triggering a request from the online learning platform 102 to the video message generator 128 to generate a new video featuring a real-time tutor. The real-time tutor featured in the video message is in correspondence with the last educational content accessed by the user on the online learning platform 102.

Upon receiving the request, the video message generator 128 generates the video content and uploads it to the notification module 132 which notifies the online learning platform 102 that the video is ready for viewing.

Following this notification, the online learning platform 102 delivers a video message notification to the user's device 504. When the user receives this notification and interacts with it, the user device 504 directs them to the online learning platform 102, where they can view the personalized video message. The notification delivery process 500 ensures that the user receives timely and relevant video content in correspondence to the user's educational needs, enhancing their learning experience and engagement with the course material.

An example of the notification delivery process 500 involves a high school student, Emma, who receives a personalized video message from the real-time tutor as she prepares for her final exams in World History. Initially, Emma accessed her course material through the browser 504, prompting the online learning platform 102 to request video generation from the video message generator 128. This request is for a video message featuring a real-time tutor designed to resemble a historical persona who will offer encouragement and study tips specifically tailored to Emma's needs.

The video message generator 128 responds by generating the video content and uploading it to a notification module 132. Once the video is uploaded, the notification module 132 notifies the online learning platform 102 that the video is ready and sends a notification to Emma's device 504, alerting her of the new video message.

When Emma receives the notification and taps on it, her device directs her back to the online learning platform 102, where she can view the personalized video message. The real-time tutor in the video highlights a particular historical era that Emma previously found challenging, offering study tips and emphasizing the importance of this era for her upcoming exam. This personalized online learning platform 102 approach helps Emma feel supported and motivated, encouraging her to focus on her studies with renewed determination.

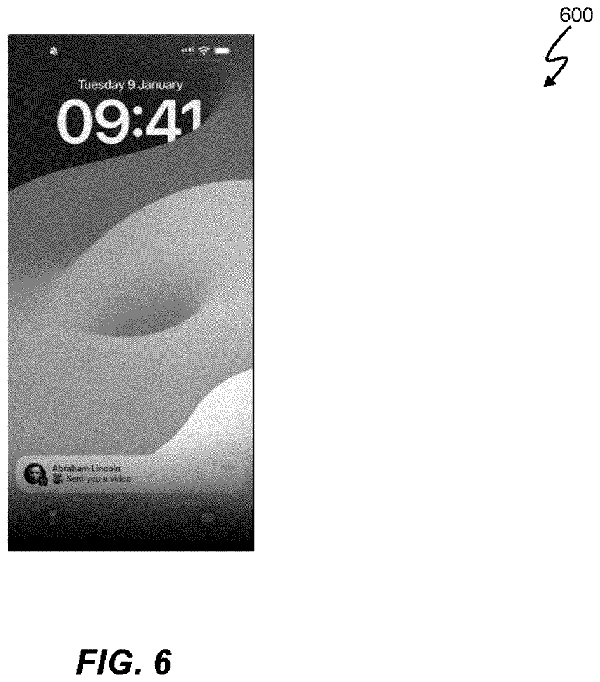

FIG. 6 discloses the screenshot of the user's device 600 when the video notification 602 shared with the user has popped up on the screen.

The video notification 602 is shared with the user already enrolled in the online learning platform 102 for re-engaging them. The video notification 602 is shared with the user on the user device 600, which may be any device that is compatible with the online learning application, including smartphones, tablets, laptops, desktops, iPads, and so on.

The video notification 602 pop-up shown on the screen of the user device 600 includes an image 604 and name 606 of the real-time tutor who is sending the video message to the user. The video notification 602 pops up on the screen of the user device 600 with a message, for instance, in the case of the present example, the pop-up message is ‘Abraham Lincoln has sent you a video’ with an image 604 and name 606 of Abraham Lincoln.

A real-time video message from a great historical persona belonging to the same field which the student is studying currently, for example, for AP US History George Washington, Genghis Khan for world history, Chantal Starwood for AP Bio, Jane Goodall for environmental science, and so on engages the user and re-engages them into the online learning platform. The video notification 602 is sent to the user after every 24 hours of inactivity. Initially, after 24 hours of inactivity, a text message is sent, if the user does not respond to that, then the video notification is shared 602 with the user.

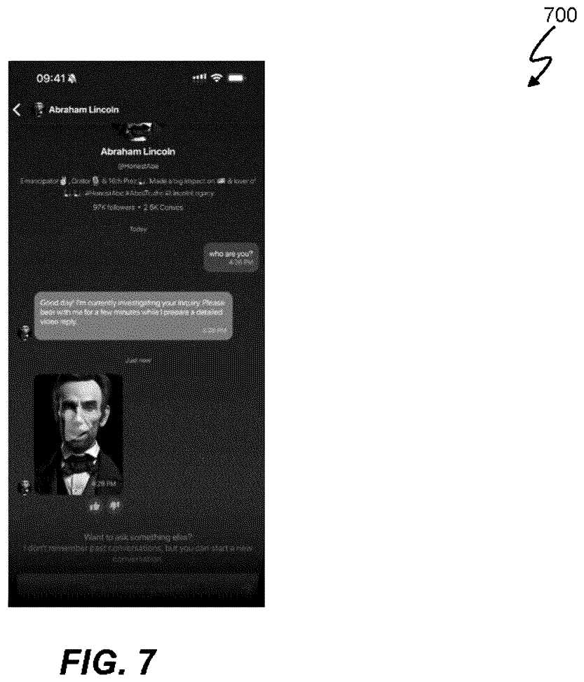

FIG. 7 depicts an exemplary user interface 700 that appears when the user interacts with the real-time tutor. The user may also interact with the real-time tutor. The user interface 700 is a sort of chat window using which the user can interact with the real-time tutor. The image 702 and name 704 of the real-time tutor are displayed on the top left corner of the user interface 700. The details 706 about the real-time tutor i.e., Abraham Lincoln is displayed in the center of the user interface. The interactions between the user and the real-time tutor are shown below. Further, a video 710 is generated by the AI engine 124 in response to the user's query 708. The user can click on the video 710 to listen to the response. The video 710 is generated in a similar way as a notification is generated.

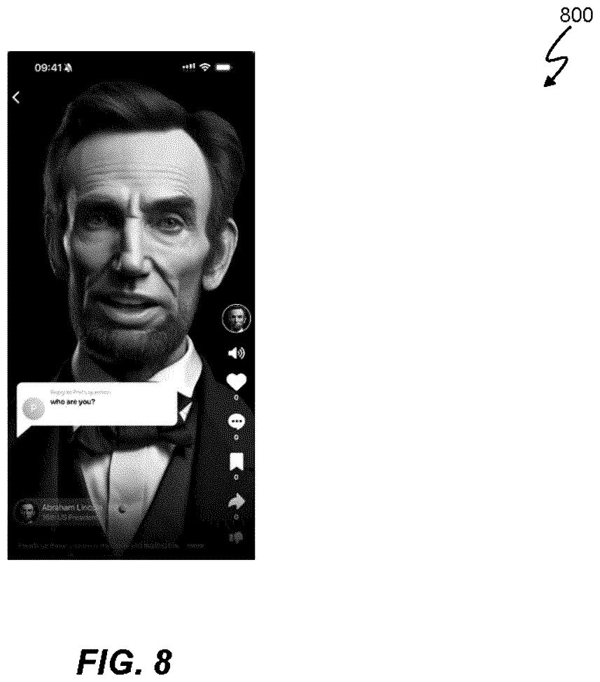

FIG. 8 depicts an exemplary user interface 800 disclosing the video 802 featuring a real-time tutor 804 shared with the user. Upon clicking on the video 710, the user can see the full-screen video 802 featuring the real-time tutor 804, Abraham Lincoln in the case of the present example.

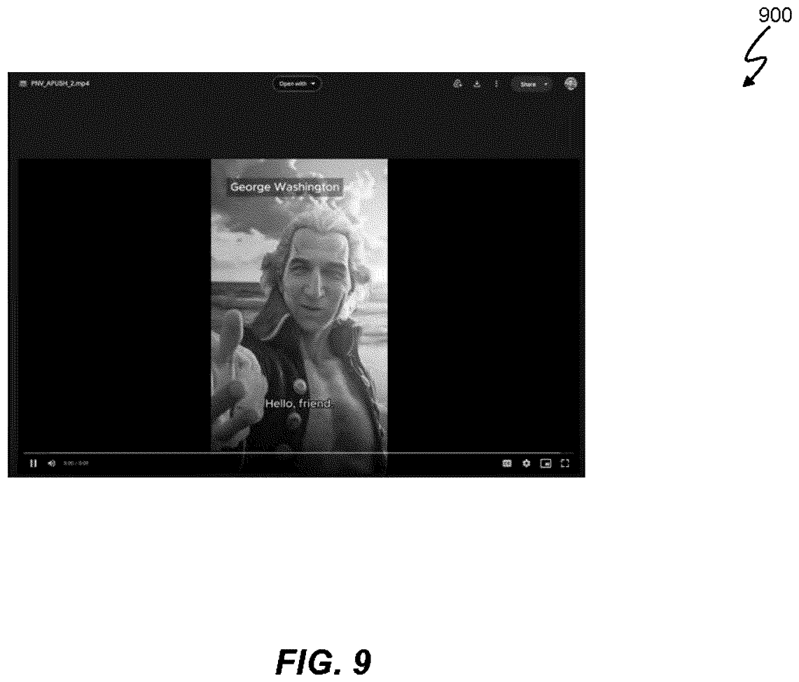

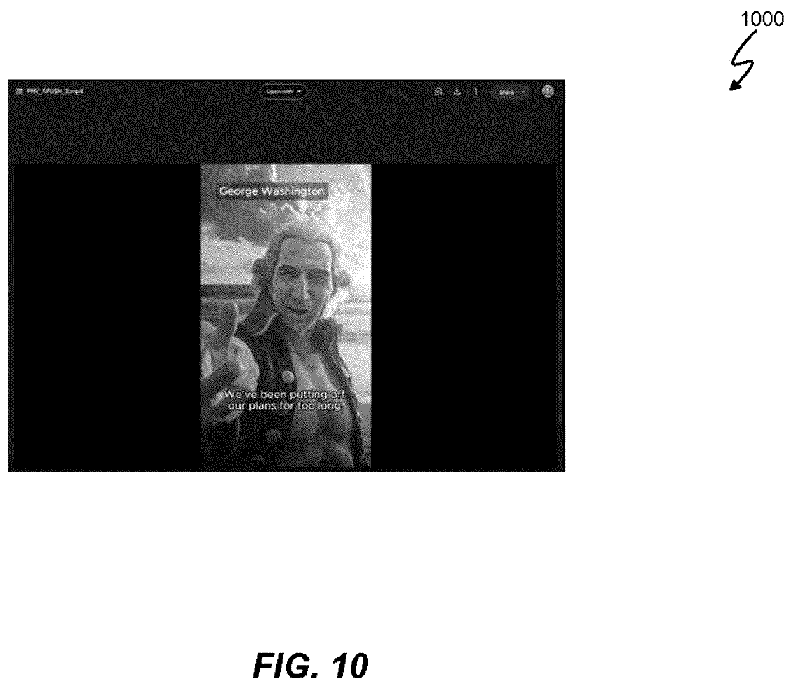

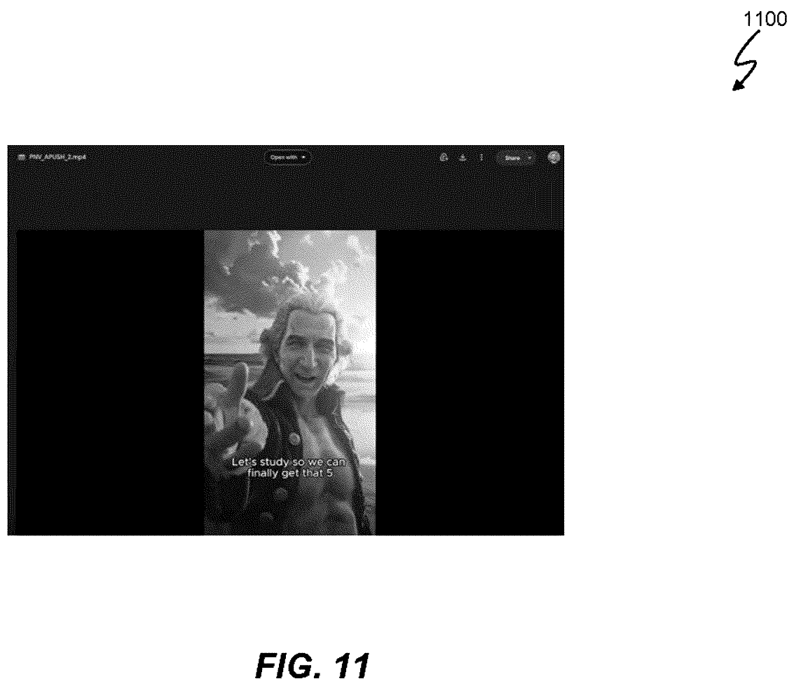

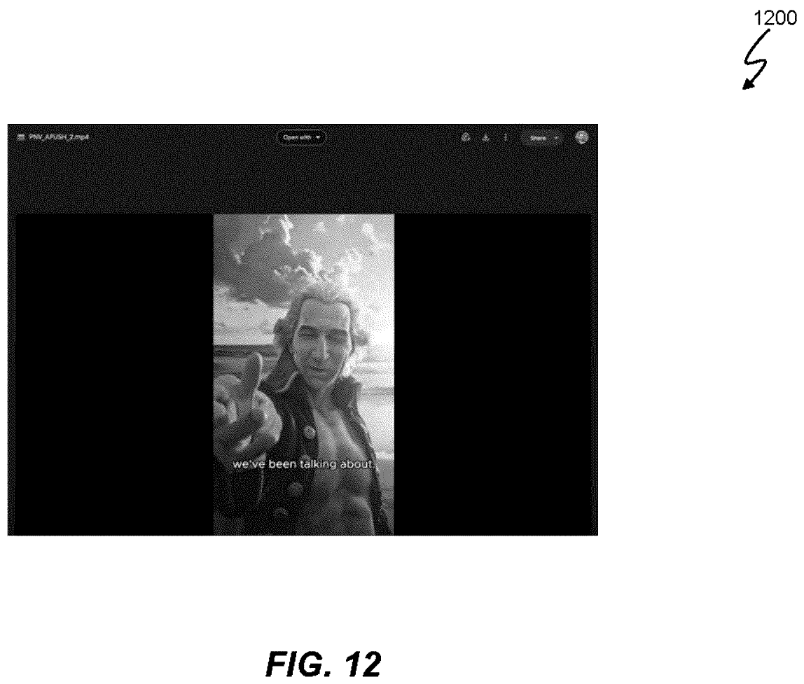

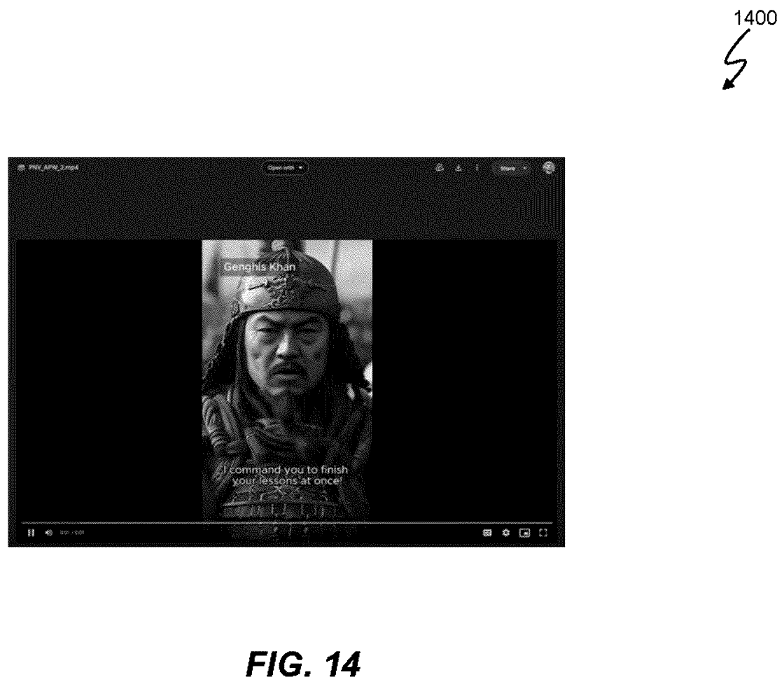

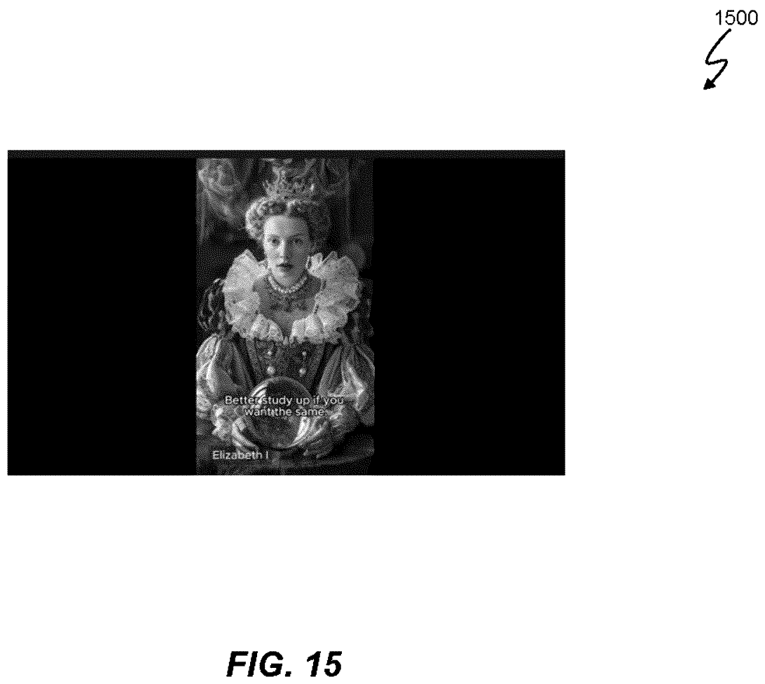

FIGS. 9-15 depict exemplary user interfaces disclosing the video notification shared with the user enrolled with an online learning platform 102, featuring a real-time tutor.

FIGS. 9-12 disclose the screenshots of the video notification shared with the user. The message is shared by the real-time tutor, i.e., ‘George Washington’ which includes ‘Hello Friends, we have been putting off our plans for too long. Let's study so we can finally get that 5, we have been talking about’.

The message from George Washington reminds the user about the user's study goal i.e., achieving 5 points in the AP test. These details are collected by the data collector 116 from the user profile details 108.

Similarly, based on the study goals, the exam timetable, user engagement with the online learning platform 102, and so on, the video messages are generated by the video message generator 128 integrated within the AI engine 124. For example, the user interfaces 1300, 1400, and 1500 show video notifications from real-time tutors like George Washington, Genghis Khan, and Queen Elizabeth One respectively. These tutors provide the video message to the user, for example, the George Washington in the user interface 1300 provides a notification indicating ‘Do you know how long it takes to dig an 800-yard trench? Trust me, it's a lot faster to prepare for your AP exam using TeachTap and a lot less dirty. So dig in.’, the Genghis Khan in the user interface 1400 provides a notification indicating ‘I command you to finish your lessons at once. I do this as a helpful AI tutor and possibly as a loving distant relative of yours.’, the Queen Elizabeth One in the user interface 1500 provides a notification indicating ‘I see great things in your future. Victory, riches, fame. Oh, wait, that's my past. Better study up if you want the same.’, and so on. FIG. 13 depicts frames from a video that progresses through to deliver a message from George Washington.

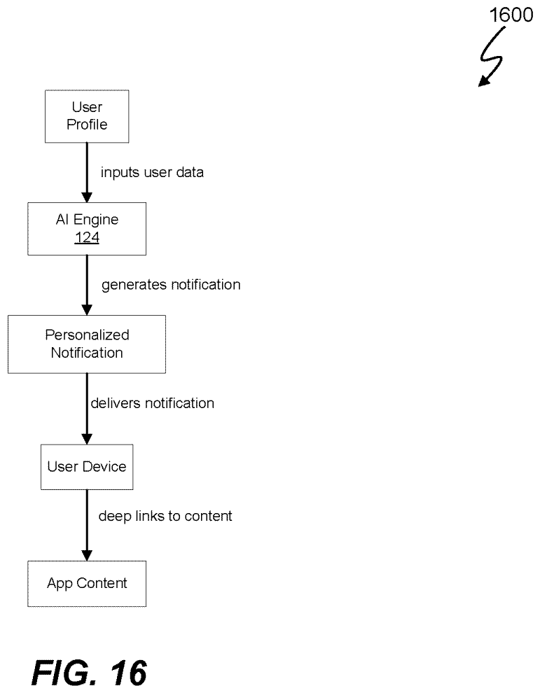

FIG. 16 depicts a personalized notification delivery process 1600 to the user device, which is an embodiment of the notification generation process 200 for retaining users enrolled in an online learning platform 102 of FIG. 2.

The personalized notification delivery process 1600 illustrates the re-engagement of the users already enrolled in the online learning platform 102 by sharing personalized notifications with the user.

The heart of the block diagram is the User Profile details 108, which serves as the repository for crucial user data. This profile includes details such as the user's exam schedule, past interactions with the online learning platform 102, and the user's specific study goals. This rich dataset is crucial as it provides the necessary context for generating the notifications in correspondence to each user's unique needs and preferences.

Next, the User Profile details 108 is inputted into the AI engine 124. The AI engine 124 is the brain of the notification generation system 100, which utilizes advanced algorithms and machine learning techniques to analyze the collected user data. By examining patterns and insights from the user's past behavior i.e., user engagement, duration of the online learning session, and so on, and current study goals, the AI engine 124 can generate highly personalized notifications 1602. These notifications 1602 are designed to be timely and relevant, aiming to re-engage users by directing them to specific study tasks that align with their preparation needs.

Once the AI engine 124 has crafted a personalized notification 1602, it is sent to the User Device 1604. This step ensures that the user receives the notification 1602 on their personal device 1604, whether it be a smartphone, tablet, computer, or any other device compatible with the online learning platform 102. The delivery of these notifications 1602 is critical for maintaining the user's engagement with the online learning platform 102, as it prompts them to take immediate action.

Upon receiving the notification 1602, the user's device deep-links to the App Content 1606. This means that when the user taps on the notification 1602, they are not just brought back to the app i.e., online learning platform 102, but are directed specifically to the relevant educational content that the notification 1602 pertains to. For instance, if the notification 1602 reminds the user to revisit a particular unit test or study material they struggled with, tapping on the notification 1602 will take the user directly to that part of the app i.e., online learning platform 102. This seamless integration ensures that users can quickly and efficiently access the resources they need without unnecessary navigation, thereby optimizing their online learning sessions and helping them stay focused on their goals.

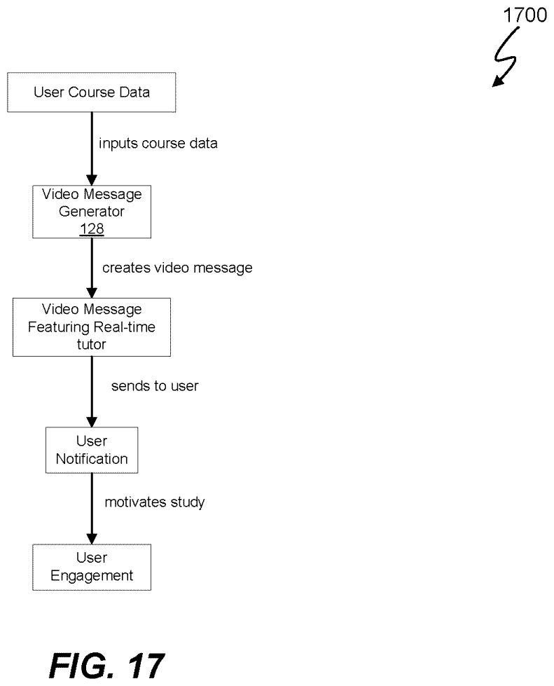

FIG. 17 depicts a user engagement process 1700 by sending personalized notifications to the user, which is an embodiment of the notification generation process 200 for retaining users enrolled in an online learning platform 102 of FIG. 2.

The user engagement process 1700 illustrates boosting student engagement in the online learning platform 102 by utilizing AI-generated motivational videos featuring historical personas in the form of the real-time tutors. The user engagement process 1700 begins with User Course Data 1702, which incorporates information about the courses the user is enrolled in, their progress, and specific study goals. The User Course Data 1702 is obtained from the user profile details 108 and user performance data 112 and forms the foundation for generating relevant and personalized content.

This User Course Data 1702 is then fed into the Video Message Generator 128, integrated within the AI engine 124 (not shown in the figure). The Video Message Generator 128 utilizes generative AI technology to analyze the course data and create a video message. The Video Message Generator 128 is capable of synthesizing realistic video content that features a virtual real-time tutor. The real-time tutor in the video delivers motivational messages, study tips, and personalized encouragement based on the user's current coursework and study needs.

Once the Video Message Generator 128 has created the video message, the real-time tutor is integrated into that video message, thereby the resultant video becomes a Video Message Featuring the Real-Time Tutor 1704. This video message is designed to be engaging and relevant, aimed at sparking the user's curiosity and encouraging them to continue their studies. The Video Message Featuring the Real-Time Tutor 1704 is then delivered to the user in the form of a User Notification 1706 using the notification module 132 (not shown in the figure). This notification 1706 is sent directly to the user's device, ensuring that the motivational content reaches them on time.

Finally, when the user receives the User Notification 1706, it triggers User Engagement 1708. This step is important as it aims to motivate the user to return to their studies and interact with the online learning platform 102. The Video Message Featuring the Real-Time Tutor 1704 is designed to re-engage the user by providing encouragement and personalized study tips, thereby helping the user to stay on track with their study goals and improve their academic performance.

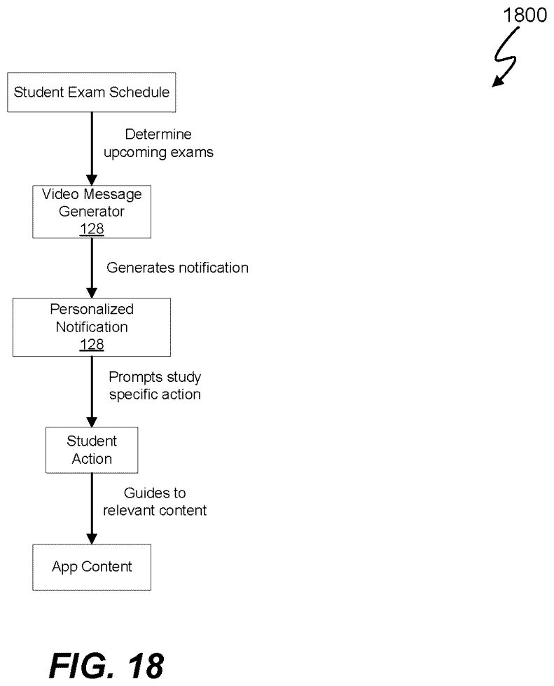

FIG. 18 depicts an exam schedule-based notification generation process 1800, which is an embodiment of the notification generation process 200 for retaining users enrolled in an online learning platform 102 of FIG. 2.

The exam schedule-based notification generation process 1800 illustrates helping students prepare for exams by delivering personalized notifications to guide their study goals. The exam schedule-based notification generation process 1800 begins with the Student Exam Schedule 1802, which contains information about the dates and details of the exams the student needs to prepare for. This exam schedule is fed into the Video Message Generator 128, which analyzes the data to identify upcoming exams.

Based on the analysis, the Video Message Generator 128 generates a Personalized Notification 1804. This notification 1804 is specifically generated to remind the students of the upcoming exams and to encourage and re-engage them to take specific study actions that will help them prepare effectively.

When the student receives the Personalized Notification 1804, it prompts them to take a specific study action, such as reviewing a particular unit, taking a practice test, or revisiting previous material they found challenging using a deep link. This step ensures that the student focuses their study efforts on the most relevant tasks that align with their preparation needs.

Finally, the Student Action 1806 guided by the personalized notification 1804 leads the student to the App Content 1808 i.e., the educational content of the online learning platform 102. This ensures that the student is directed to the relevant educational content within the online learning platform 102, making it easy for them to access the resources they need to study effectively. By reorganizing the study schedule and providing timely, actionable notifications, the notification generation system 100 aims to improve the student's exam readiness and overall academic performance.

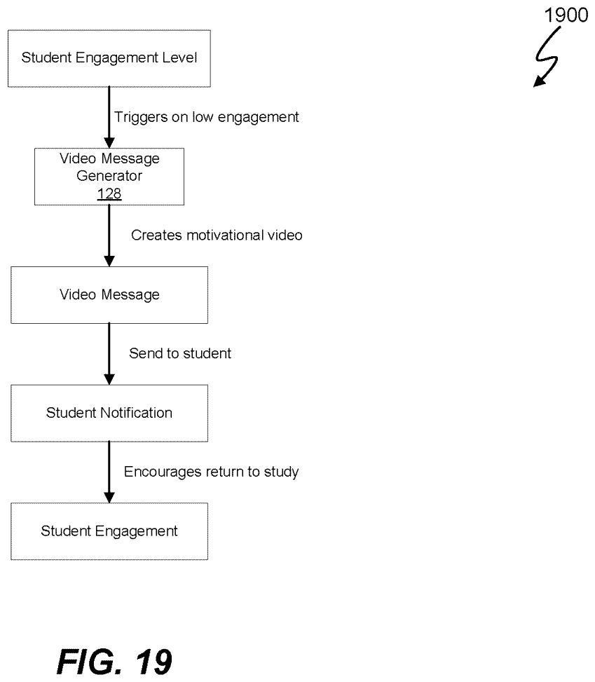

FIG. 19 depicts a video notification featuring a real-time tutor generation process 1900, which is an embodiment of the notification generation process 200 for retaining users enrolled in an online learning platform 102 of FIG. 2.

The video notification featuring a real-time tutor generation process 1900 illustrates an engagement the student to boost student engagement in the online learning platform 102 by utilizing AI-generated motivational videos featuring historical personas in the form of the real-time tutors. The video notification featuring a real-time tutor generation process 1900 begins with monitoring the Student Engagement Level 1902, which tracks how actively the student is participating in their studies on the online learning platform 102. The Student Engagement Level 1902 is collected using the user engagement data 110 on the online learning platform 102. When this engagement level drops below a certain threshold, it triggers the Video Message Generator 128.

The Video Message Generator 128 is an advanced AI engine 124 tasked with creating personalized video messages that utilize advanced AI NLP (Artificial Intelligence Natural Language Processing) techniques. Upon detecting low engagement, the Video Message Generator 128 generates a motivational video 1902 featuring the historical persona as a real-time tutor. The low engagement is determined based on the user engagement data 110 collected by the data collector 116 (not shown in the figure). These videos 1902 are generated in correspondence to address the specific needs and challenges that the student might be facing, providing encouragement and strategies to re-engage with their studies.

Once the Video Message Generator 128 creates the Video Message 1904, this motivational content is prepared for delivery. The video message 1904 is then sent as a Student Notification 1906 using notification module 132 (not shown in the figure), which appears on the student's device. This notification is designed to be compelling and timely, catching the student's attention and prompting them to watch the video message 1904.

The final step is Student Re-engagement 1906 when the student receives and views the notification containing the real-time tutor's motivational video message 1904, it aims to inspire and motivate them to return to their studies. This re-engagement is crucial for maintaining consistent study habits and ensuring that the student remains on track with their educational goals.

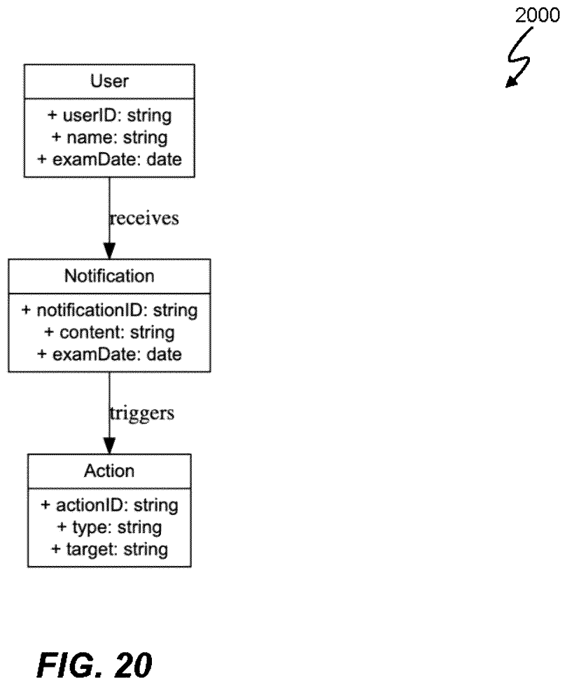

FIG. 20 depicts an exemplary data structure 2000 for organizing data to generate personalized notifications and video messages for the user. The data structure 2000 described in FIG. 20 represents the components and relationships involved in managing personalized notifications for users enrolled on an online learning platform 102.

At the heart of the data structure 2000, is the User entity 2002. Each user 2002 is identified by a unique userID and also has associated attributes such as name and examDate. The examDate indicates when the user has scheduled exams, which is crucial for timing the notifications appropriately. Linked to the User entity 2002 is the Notification entity 2004. Each notification 2004 is identified by a unique notificationID and includes content, which represents the message or alert intended for the user. The examDate attribute within the Notification entity 2004 mirrors the user's exam date, ensuring that the notifications 2004 are contextually relevant to their upcoming exams.

The Notification entity 2004 is connected to the Action entity 2006. Each action 2006 is identified by a unique actionID and includes type and target attributes. The type indicates the nature of the action (e.g., reminding the user to study, or providing a link to a practice test), while the target specifies the exact resource or section of the online learning platform 102 that the user should focus on. This relationship signifies that a notification triggers an action 2006, highlighting the intended outcome of sending the notification by prompting the user to engage in a specific study-related activity.

The data structure 2000 ensures that users 2002 receive timely and relevant notifications 2004 that guide them towards specific actions 2006 aimed at improving their exam preparedness, thereby enhancing their overall learning experience.

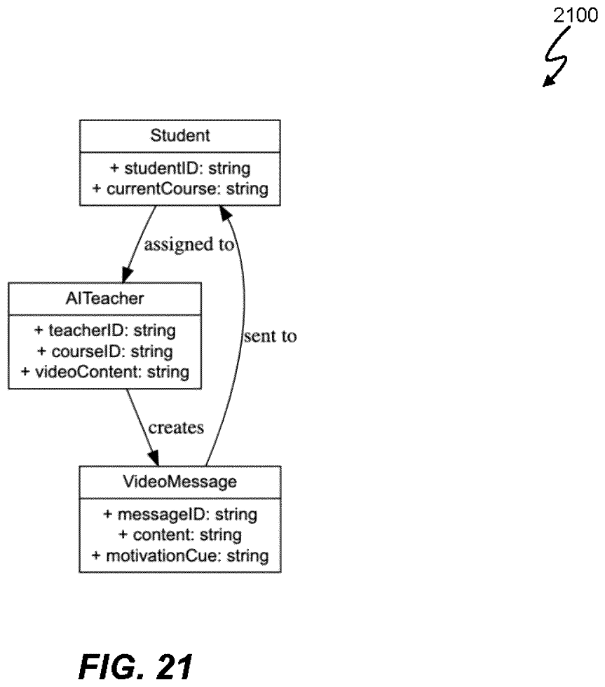

FIG. 21 depicts an exemplary data structure 2100 for organizing data to share personalized notifications and video messages featuring real-time tutors.

The data structure 2100 described in FIG. 21 represents the components and interactions involved in delivering personalized video messages from real-time tutors to students on an online learning platform 102.

At the heart of the data structure 2100 is the Student entity 2102. Each student 2102 is identified by a unique studentID and has attributes such as currentCourse, which indicates the course the student is currently enrolled in. This information is essential for generating video messages to be relevant to the student's academic focus.

Linked to the Student entity 2102 is the Real-Time Tutor entity 2104. Each Real-time tutor 2104 is identified by a unique teacherID and is associated with a specific courseID, which corresponds to the course they are designed to teach. The videoContent attribute contains the content of the motivational video that the Real-time tutor 2104 will deliver. The relationship between Student 2102 and Real-Time Tutor 2104 signifies that a student 2102 is assigned to a Real-time tutor 2104, indicating that each student 2102 has a designated Real-time tutor 2104 relevant to their current course.

The Real-Time Tutor entity 2104 is connected to the VideoMessage entity 2106. Each video message 2106 is identified by a unique messageID and includes content, which represents the actual message intended to motivate the student 2102. The motivationCue attribute provides specific motivational prompts designed to engage the student 2102 effectively. This relationship denotes that an Real-time tutor 2104 creates a video message 2106, highlighting the role of the Real-time tutor 2104 in generating personalized motivational content.

Finally, the VideoMessage entity 2106 is linked back to the Student entity 2102, indicating that the video message 2106 is sent to the student 2102. This relationship completes the loop, showing that the personalized motivational video, once created by the Real-time tutor 2104, is delivered directly to the student 2102 to encourage their continued engagement and study efforts.

The data structure 2100 ensures that students 2102 receive targeted and personalized motivational video messages 2106 from Real-time tutors 2104 thereby, providing a more engaging and supportive learning environment to the user's specific academic needs.

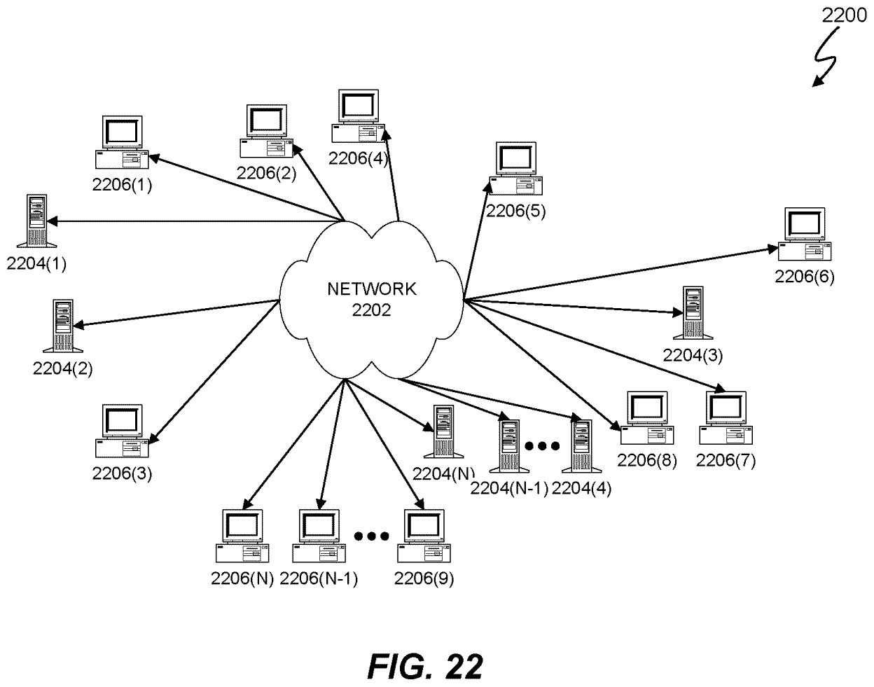

FIG. 22 is a block diagram illustrating a network environment in which a notification generation system 100 and process 200 for retaining users enrolled in an online learning platform 102 may be practiced. Network 2202 (e.g. a private wide area network (WAN) or the Internet) includes several networked server computer systems 2204(1)-(N) that are accessible by client computer systems 2206(1)-(N), where N is the number of server computer systems connected to the network. Communication between client computer systems 2206(1)-(N) and server computer systems 2204(1)-(N) typically occurs over a network, such as a public switched telephone network over asynchronous digital subscriber line (ADSL) telephone lines or high-bandwidth trunks, for example, communications channels providing T1 or OC3 service. Client computer systems 2206(1)-(N) typically access server computer systems 2204(1)-(N) through a service provider, such as an internet service provider (“ISP”) by executing application-specific software, commonly referred to as a browser, on one of client computer systems 2206(1)-(N).

Client computer systems 2206(1)-(N) and/or server computer systems 2204(1)-(N) are specialized computers programmed to improve conventional computer systems to implement and utilize the notification generation system 100 and process 200 for retaining users enrolled in an online learning platform 102. The type of computer system that can be specially programmed to implement and utilize the notification generation system 100 and process 200 for retaining users enrolled in an online learning platform 102 includes a mainframe, a mini-computer, a personal computer system including notebook computers, a wireless, mobile computing device (including personal digital assistants, smartphones, and tablet computers). These computer systems are typically designed to provide computing power to one or more users, either locally or remotely. Each computer system may also include one or a plurality of input/output (“I/O”) devices coupled to the system processor to perform specialized functions. Tangible, non-transitory memories (also referred to as “storage devices”) such as hard disks, compact disk (“CD”) drives, digital versatile disk (“DVD”) drives, and magneto-optical drives may also be provided, either as an integrated or peripheral device. In at least one embodiment, the notification generation system 100 and process 200 for retaining users enrolled in an online learning platform 102 can be implemented using code stored in a tangible, non-transient computer-readable medium and executed by one or more processors. In at least one embodiment, the notification generation system 100 and process 200 for retaining users enrolled in an online learning platform 102 can be implemented completely in hardware using, for example, logic circuits and other circuits including field programmable gate arrays.

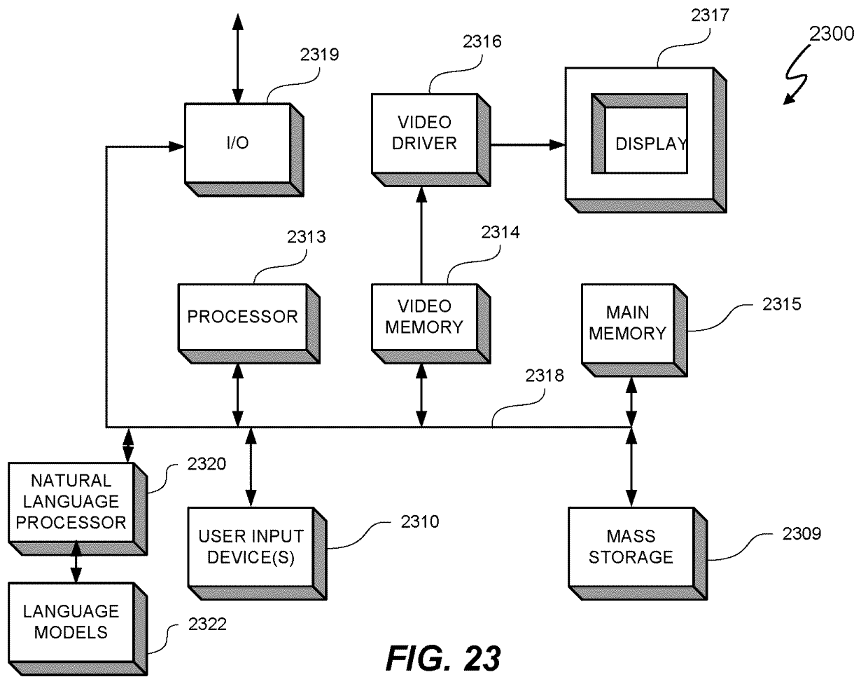

Embodiments of the notification generation system 100 and process 200 for retaining users enrolled in an online learning platform 102 can be implemented on a computer system such as a special-purpose, special-programmed computer 2300 illustrated in FIG. 23. The input user device(s) 2310, such as a keyboard and/or mouse, are coupled to a bi-directional system bus 2318. The input user device(s) 2310 are for introducing user input to the computer system and communicating that user input to the processor 2313. The computer system of FIG. 23 generally also includes a non-transitory video memory 2314, non-transitory main memory 2315, and non-transitory mass storage 2309, all coupled to the bi-directional system bus 2318 along with input user device(s) 2310 and processor 2313. The mass storage 2309 may include both fixed and removable media, such as a hard drive, one or more CDs or DVDs, solid state memory including flash memory, and other available mass storage technology. Bus 2318 may contain, for example, 32 of 64 address lines for addressing video memory 2314 or main memory 2315. The system bus 2318 also includes, for example, an n-bit data bus for transferring DATA between and among the components, such as CPU 2309, main memory 2315, video memory 2314, and mass storage 2309, where “n” is, for example, 32 or 64. Alternatively, multiplex data/address lines may be used instead of separate data and address lines.

I/O device(s) 2319 may provide connections to peripheral devices, such as a printer, and may also provide a direct connection to a remote server computer system via a telephone link or to the Internet via an ISP. I/O device(s) 2319 may also include a network interface device to provide a direct connection to a remote server computer system via a direct network link to the Internet via a POP (point of presence). Such connection may be made using, for example, wireless techniques, including digital cellular telephone connection, Cellular Digital Packet Data (CDPD) connection, digital satellite data connection, or the like. Examples of I/O devices include modems, sound and video devices, and specialized communication devices such as the aforementioned network interface.

Computer programs and data are generally stored as code in a non-transient computer-readable medium such as flash memory, optical memory, magnetic memory, compact disks, digital versatile disks, and any other type of memory. The computer program is loaded from a memory, such as mass storage 2309, into main memory 2315 for execution. Computer programs may also be in the form of electronic signals modulated in accordance with the computer program and data communication technology when transferred via a network. In at least one embodiment, Java applets or any other technology is used with web pages to allow a user of a web browser to make and submit selections and allow a client computer system to capture the user selection and submit the selection data to a server computer system.

The processor 2313, in one embodiment, is a microprocessor manufactured by Motorola Inc. of Illinois, Intel Corporation of California, or Advanced Micro Devices of California. However, any other suitable single or multiple microprocessors or microcomputers may be utilized. Main memory 2315 consists of dynamic random access memory (DRAM). Video memory 2314 is a dual-ported video random access memory. One port of the video memory 2314 is coupled to the video amplifier 2316. The video amplifier 2316 is used to drive the display 2317. Video amplifier 2316 is well-known in the art and may be implemented by any suitable means. This circuitry converts pixel DATA stored in video memory 2314 to a raster signal suitable for use by display 2317. Display 2317 is a type of monitor suitable for displaying graphic images.

The computer system described above is for purposes of example only. The notification generation system 100 and process 200 for retaining users enrolled in an online learning platform 102 may be implemented in any type of computer system or programming or processing environment. It is contemplated that the notification generation system 100 and process 200 for retaining users enrolled in an online learning platform 102 might be run on a stand-alone computer system, such as the one described above. The notification generation system 100 and process 200 for retaining users enrolled in an online learning platform 102 might also be run from a server computer system that can be accessed by a plurality of client computer systems interconnected over an intranet network. Finally, the notification generation system 100 and process 200 for retaining users enrolled in an online learning platform 102 may be run from a server computer system that is accessible to clients over the Internet.

Although embodiments have been described in detail, it should be understood that various changes, substitutions, and alterations can be made herein without departing from the spirit and scope of the invention as defined by the appended claims.

What is claimed is:

1. A method of guiding and constraining an artificial intelligence (AI) engine to generate and share a notification for re-engaging the user already enrolled in an online learning platform, the method comprises:
executing code using one or more processors of a computer system to cause the computer system to perform operations comprising:
collecting one or more user data including user profile details, user engagement data, and user performance data, wherein the user profile details include user identification, user preferences, user-defined study goals, and user engagement data including interaction logs, time spent on specific tasks, and frequency of access to educational content or online learning platform;
analyzing one or more user data to determine the exact timings for sending notifications to the user and relevant educational content in correspondence to the user's study goal, wherein the timings are determined based on the user profile details and the user engagement data;
generating prompts for guiding and constraining the AI engine to generate a video message featuring a virtual character in correspondence to the user's past online learning session;
transferring the prompt to the AI engine to generate a video notification for the user by integrating the virtual character in the video and personalizing the video content based on the user's study progress and goals; and
sharing the video notification to the user that includes the real-time virtual character integrated within the message, wherein the virtual character interacts with the user and tries to motivate and retain the user in the online learning platform.

2. The method of claim 1 wherein the virtual character is an AI (Artificial Intelligence) generated real-time tutor that includes historical personas from the corresponding educational context.

3. The method of claim 1 wherein the user's past online learning session includes the course studied by the user during the online learning session, based on which the prompts are generated to guide the AI engine.

4. The method of claim 1 wherein the video notification includes the message generated in correspondence to the user's requirements and a deep link to the specific content within the online learning platform.

5. The method of claim 1 wherein machine learning algorithms are utilized to predict the optimal study material for each user based on their past performance and engagement data comprises:
collecting user past performance data from user details, and user engagement data;
extracting relevant features from the collected data, including scores, online learning session duration, and frequency of accessing the educational content;
training machine learning module using the extracted features to identify patterns and correlations between user engagement and performance improvements; and
utilizing the trained machine learning models to predict the optimal educational content for each user, based on their current performance and engagement patterns.

6. The method of claim 5 wherein the user performance data includes scores on practice tests, quizzes, and assignments, and user engagement data consists of the frequency and duration of online learning sessions, types of educational content accessed, and interaction patterns within the online learning platform.

7. The method of claim 5 wherein the optimal educational content includes the educational content that is most likely to improve the user's performance and recommends educational content that aligns with the user's weaknesses and strengths.

8. The method of claim 1 wherein the notification in the form of a text message that is shared with the user after an inactivity of 24 hours from the user end.

9. The method of claim 1 is wherein the notification in the form of a video message is shared with the user after 48 hours of inactivity from the user end, thereby continuously sharing the video notifications every 24 hours of inactivity.

10. The method of claim 1 wherein the user details and user engagement data are analyzed after every 15 minutes ensuring that the notifications are not shared redundantly within the same inactivity period.

11. The method of claim 1 wherein the text notification further includes a deep link that redirects the user to the specific educational content within the online learning platform as indicated in the deep link.

12. The method of claim 1 wherein the user can select the frequency and the content of the notifications shared with them based on their engagement patterns.

13. The method of claim 1 further comprises:
a feedback loop to collect user responses and engagement metrics after viewing the video notifications, wherein the feedback loop provides information related to refinement of the future prompts and notification timings based on user feedback and engagement metrics.

14. A system to guide and constrain an Artificial Intelligence (AI) engine to generate and share a notification for re-engaging the user already enrolled in an online learning platform comprises:
one or more processors; and
a memory, coupled to the one or more processors, storing code that when executed causes the one or more processors to perform operations comprising:
collecting one or more user data including, user profile details, user engagement data, and user performance data using a data collector, wherein the user profile details include user identification, user preferences, user-defined study goals, and user engagement data include interaction logs, time spent on specific tasks, and frequency of access to educational content or online learning platform;
analyzing the one or more user data to determine the exact timings for sending notifications to the user and relevant educational content in correspondence to the user's study goal using an analyzer, wherein the timings are determined based on the user profile details and the user engagement data;
generating prompts using a prompt generator for guiding and constraining the AI engine in creating a video message featuring a virtual character in correspondence to the user's past online learning session;
transferring the prompt to the AI engine to generate a video notification for the user by integrating the virtual character in the video and personalizing the video content based on the user's study progress and goals; and
sharing the video notification with the user using a notification module that includes the real-time virtual character integrated within the message, wherein the virtual character interacts with the user and tries to motivate and retain the user in the online learning platform.

15. The system of claim 14 wherein the AI engine personalizes the tone and style of the video messages based on user preferences, such as a formal or informal approach.

16. The system of claim 14 wherein the data collector continuously updates the user profile with new data from each user interaction.

17. The system of claim 14 wherein the analyzer is configured to:
analyze the collected user details and user engagement data;
determine the exact timings for sending notifications to the user based on the analysis;
identify relevant educational content that corresponds to the user's study goals.

18. The system of claim 14 includes a scheduler that synchronizes with external calendars and scheduling tools better to align notifications with the user's overall schedule.

19. The system of claim 14 further comprises a monitoring module configured to:
track user activity and reset inactivity timers upon user interaction with the online learning platform;
maintain a record of sent notifications and video messages to avoid repetition.

20. The system of claim 14 wherein the notification module is further configured to:
receive the video notification generated by the AI engine, ensuring that the video notification includes a real-time virtual character integrated within the message;
deliver the video notification to the user's device.

21. The system of claim 14 wherein the notification module allows the virtual character to interact with the user through personalized messages aimed at motivating and retaining the user in the online learning platform.

22. The system of claim 14 further comprises:
a feedback loop within the notification module to collect user responses and engagement metrics after viewing the video notifications, wherein the feedback loop provides information related to refinement of the future prompts and notification timings based on user feedback and engagement metrics.
